(19) United States
(12) Patent Application Publication
(10) Pub. No.: US 2013/0057929 A1
(43) Pub. Date: Mar. 7, 2013

(54) IMAGE READING APPARATUS AND IMAGE FORMING APPARATUS INCLUDING THE SAME

(71) Applicant: Takeshi Niimura, Yokohama-shi (JP)

(72) Inventor: Takeshi Niimura, Yokohama-shi (JP)

(73) Assignee: CANON KABUSHIKI KAISHA, Tokyo (JP)

(21) Appl. No.: 13/600,520

(22) Filed: Aug. 31, 2012

(30) Foreign Application Priority Data
Sep. 2, 2011 (JP) 2011-191221
Aug. 10, 2012 (JP) 2012-178122

(51) Int. Cl. H04N 1/04

(52) U.S. Cl. 358/474

(57) ABSTRACT

Provided is an image reading apparatus, including: a placing member on which an original is to be placed; a reading section arranged so as to be opposed to the original across the placing member and reading an image of the original placed on the placing member; a casing which supports an outer peripheral edge portion of the placing member; and a support member supporting a portion other than the outer peripheral edge portion of the placing member, the support member including an abutment portion abutting against the casing, the support member being capable of supporting the placing member under a state in which the abutment portion abuts against the casing.

### BACKGROUND OF THE INVENTION

1. Field of the Invention

The present invention relates to an image reading apparatus, and an image forming apparatus including the image reading apparatus.

2. Description of the Related Art

Referring to FIGS. 40A and 40B, a configuration of an image reading apparatus according to a comparative example is described. In FIGS. 40A and 40B, an image forming apparatus 101 is a laser beam printer or the like. An image reading apparatus 102 is arranged above the image forming apparatus 101, and the image reading apparatus 102 and the image forming apparatus 101 are used as a multifunction peripheral. The image reading apparatus 102 includes an original placing glass 106 on which an original is to be placed, and a casing 103 for supporting the original placing glass 106. Further, the image reading apparatus 102 includes a cover 104 having a pressure plate 105 for aligning the original with the original placing glass 106, and an image sensor section 107 serving as an image reading unit which is freely movable inside the casing 103. A drive unit (not shown) for driving the image sensor section 107 causes the image sensor section 107 to scan the original, to thereby read an image of the original.

A signal line bundle 108 is connected to the image sensor section 107. In order not to interrupt the movement of the image sensor section 107, the signal line bundle 108 is provided so as to be movable in association with the movement of the image sensor section 107 while being curved in parallel to the arrow “e” direction of FIG. 40A corresponding to a moving direction of the image sensor section 107. In the image reading apparatus 102, the image sensor section 107 moves relative to the original placing glass 106 from a home position indicated by the solid line of FIG. 40A to a reading position indicated by the two-dot chain lines of FIG. 40A. The signal line bundle 108 is arranged so as not to interrupt the operation of the image sensor section 107 while being held in contact with a lower surface of the original placing glass 106.

The original placing glass 106 is supported at its outer peripheral edges by the casing 103. The original placing glass 106 and the image sensor section 107 are arranged in proximity. When the image reading apparatus 102 receives a force by a drop impact in the arrow “F” direction of FIGS. 40A and 40B in a period in which the image reading apparatus 102 is transported, the original placing glass 106 is distorted. At this time, the lower surface of the original placing glass 106 can not be supported except the image sensor section 107. Thus, the original placing glass 106, the image sensor section 107, or both of the original placing glass 106 and the image sensor section 107 may be damaged. In view of this, the thickness of a packaging material is increased to improve its shock absorbing performance, and the thickness of the glass itself is increased to enhance the strength of the original placing glass 106.

As a result, there is a problem in that the image reading apparatus 102 and the image forming apparatus 101 including the image reading apparatus 102 cannot be reduced in size and weight. Further, there is a problem in that a packaging volume is increased and accordingly the cost of distribution is increased.

Japanese Patent Application Laid-Open No. 2010-034787 describes a configuration in which a dust removing member including a contact cleaning section for cleaning the back surface side of the original placing glass is mounted to a carriage which is provided so as to be capable of traveling along the back surface side of the original placing glass. The contact cleaning section of this configuration may be brought into contact with the back surface of the original placing glass, but cannot sufficiently support the original placing glass which receives a force by a drop impact.

### SUMMARY OF THE INVENTION

It is therefore an object of the present invention to provide an image reading apparatus capable of preventing damage to an original placing glass due to a shock in distribution without increasing the thickness of a packaging material, and capable of reducing the size and weight of the image reading apparatus through reduction in thickness of the original placing glass.

Further, it is another object of the present invention to provide an image reading apparatus, including: a placing member on which an original is to be placed; a reading section arranged so as to be opposed to the original across the placing member and reading an image of the original placed on the placing member; a casing which supports an outer peripheral edge portion of the placing member; and a support member supporting a portion other than the outer peripheral edge portion of the placing member, the support member having an abutment portion abutting against the casing, the support member being capable of supporting the placing member under a state in which the abutment portion abuts against the casing.

Further features of the present invention will become apparent from the following description of exemplary embodiments with reference to the attached drawings.

### BRIEF DESCRIPTION OF THE DRAWINGS

FIG. 1 is an explanatory perspective view for illustrating a configuration of an image forming apparatus including an image reading apparatus according to a first embodiment.

FIG. 2 is an explanatory plan view for illustrating a configuration of the image reading apparatus according to the first embodiment.

FIG. 3 is a sectional view taken along the arrow V-V of FIG. 2, for illustrating a state in which a support unit of the image reading apparatus according to the first embodiment is set at a support position for supporting an original placing glass from a lower side thereof.

FIG. 4 is an enlarged perspective view for illustrating a configuration of the support unit of the image reading apparatus according to the first embodiment.

FIG. 5A is a partially enlarged view of FIG. 3.

FIG. 5B is a partially enlarged view of the sectional view taken along the arrow V-V of FIG. 2, for illustrating a state in which the support unit of the image reading apparatus according to the first embodiment is set at a retracted position retracted from the original placing glass.

FIG. 6 is an explanatory plan view for illustrating a configuration of an image reading apparatus according to a second embodiment.

FIG. 7 is an explanatory perspective view for illustrating a configuration of an image forming apparatus including an image reading apparatus according to a third embodiment.

FIG. 8 is an explanatory sectional view for illustrating a state in which a support unit of the image reading apparatus according to the third embodiment is set at the support position for supporting the original placing glass from the lower side thereof.

FIG. 9 is an enlarged perspective view for illustrating a configuration of the support unit of the image reading apparatus according to the third embodiment.

FIG. 10 is a partially enlarged view of FIG. 8.

FIG. 11 is an explanatory perspective view for illustrating a configuration of an image reading apparatus according to a fourth embodiment.

FIG. 12 is an explanatory plan view for illustrating the configuration of the image reading apparatus according to the fourth embodiment.

FIG. 13A is a sectional view taken along the arrow XIII-XIII of FIG. 12, for illustrating a state in which a support unit of the image reading apparatus according to the fourth embodiment is set at the support position for supporting the original placing glass from the lower side thereof.

FIG. 13B is a sectional view taken along the arrow XIII-XIII of FIG. 12, for illustrating a state in which the support unit of the image reading apparatus according to the fourth embodiment is set at the retracted position retracted from the original placing glass.

FIG. 14A is a partially enlarged view of FIG. 13A.

FIG. 14B is a partially enlarged view of FIG. 13B.

FIG. 15 is an explanatory perspective view for illustrating a configuration of an image reading apparatus according to a fifth embodiment.

FIG. 16 is an explanatory plan view for illustrating the configuration of the image reading apparatus according to the fifth embodiment.

FIG. 17A is a sectional view taken along the arrow XVII-XVII of FIG. 16, for illustrating a state in which a support unit of the image reading apparatus according to the fifth embodiment is set at the support position for supporting the original placing glass from the lower side thereof.

FIG. 17B is a sectional view taken along the arrow XVII-XVII of FIG. 16, for illustrating a state in which the support unit of the image reading apparatus according to the fifth embodiment is set at the retracted position retracted from the original placing glass.

FIG. 18 is a partially enlarged view of FIG. 17A.

FIG. 19 is an explanatory perspective view for illustrating a configuration of an image forming apparatus including an image reading apparatus according to a sixth embodiment.

FIG. 20 is an explanatory plan view for illustrating a configuration of the image reading apparatus according to the sixth embodiment.

FIG. 21 is a sectional view taken along the arrow XXI-XXI of FIG. 20.

FIG. 22A is a sectional view taken along the arrow XXII-XXII of FIG. 20, for illustrating a state in which a support unit of the image reading apparatus according to the sixth embodiment is set at the support position for supporting the original placing glass from the lower side thereof.

FIG. 22B is a sectional view taken along the arrow XXII-XXII of FIG. 20, for illustrating a state in which the support unit of the image reading apparatus according to the sixth embodiment is set at the retracted position retracted from the original placing glass.

FIG. 23A is a partially enlarged view of FIG. 22A.

FIG. 23B is a partially enlarged view of FIG. 22B.

FIGS. 24A and 24B are partially enlarged perspective views of FIG. 22A and 22B, respectively.

FIG. 25 is a schematic explanatory view of FIG. 22A.

FIG. 26 is an explanatory perspective view for illustrating a configuration of an image forming apparatus including an image reading apparatus according to a seventh embodiment.

FIG. 27A is an explanatory plan view for illustrating a configuration of the image reading apparatus according to the seventh embodiment.

FIG. 27B is a sectional view taken along the arrow XXVIIB-XXVIIB of FIG. 27A.

FIG. 27C is a sectional view taken along the arrow XXVIIC-XXVIIC of FIG. 27A, for illustrating a state in which a support unit of the image reading apparatus according to the seventh embodiment is set at the retracted position retracted from the original placing glass.

FIG. 28A is a sectional view taken along the arrow XXVIIC-XXVIIC of FIG. 27A, for illustrating a state in which the support unit of the image reading apparatus according to the seventh embodiment is set at the support position for supporting the original placing glass from the lower side thereof.

FIG. 28B is a schematic explanatory view of FIG. 28A.

FIG. 29 is an enlarged perspective view for illustrating a configuration of the support unit of the image reading apparatus according to the seventh embodiment.

FIG. 30 is a partially enlarged view of FIG. 28A.

FIG. 31A is an explanatory perspective view for illustrating a configuration of an image forming apparatus including an image reading apparatus according to an eighth embodiment.

FIG. 31B is an explanatory plan view for illustrating a configuration of the image reading apparatus according to the eighth embodiment.

FIG. 32A is a sectional view taken along the arrow XXXII-XXXII of FIG. 31B.

FIG. 32B is a partially enlarged view of FIG. 32A.

FIG. 33A is an explanatory perspective view for illustrating a configuration of an image forming apparatus including an image reading apparatus according to a ninth embodiment.

FIG. 33B is an explanatory plan view for illustrating a configuration of the image reading apparatus according to the ninth embodiment.

FIG. 34A is a sectional view taken along the arrow XXXIV-XXXIV of FIG. 33B.

FIG. 34B is a partially enlarged view of FIG. 34A.

FIG. 35 is an explanatory perspective view for illustrating a configuration of an image forming apparatus including an image reading apparatus according to a tenth embodiment.

FIG. 36A is an explanatory plan view for illustrating a configuration of the image reading apparatus according to the tenth embodiment.

FIG. 36B is a sectional view taken along the arrow XXXVIB-XXXVIB of FIG. 36A.

FIG. 37A is an explanatory perspective view for illustrating a configuration of an image forming apparatus including an image reading apparatus according to an eleventh embodiment.

FIG. 37B is an explanatory plan view for illustrating a configuration of the image reading apparatus according to the eleventh embodiment.

FIG. 38 is an explanatory perspective view for illustrating a configuration of an image forming apparatus including an image reading apparatus according to a twelfth embodiment.

FIG. 39A is an explanatory plan view for illustrating a configuration of the image reading apparatus according to the twelfth embodiment.

FIG. 39B is a sectional view taken along the arrow XXXIXB-XXXIXB of FIG. 39A.

FIG. 40A is an explanatory perspective view for illustrating a configuration of an image forming apparatus including an image reading apparatus according to a comparative example.

FIG. 40B is an explanatory sectional view of the image reading apparatus according to the comparative example.

### DESCRIPTION OF THE EMBODIMENTS

In the following, image forming apparatuses each including an image reading apparatus according to exemplary embodiments of the present invention are described with reference to the attached drawings. Note that, dimensions, materials, shapes, relative positions of components, and the like to be described in the following embodiments may be changed as appropriate depending on a configuration of an apparatus to which the present invention is applied, or various conditions. The scope of the present invention is not limited to the following embodiments.

### First Embodiment

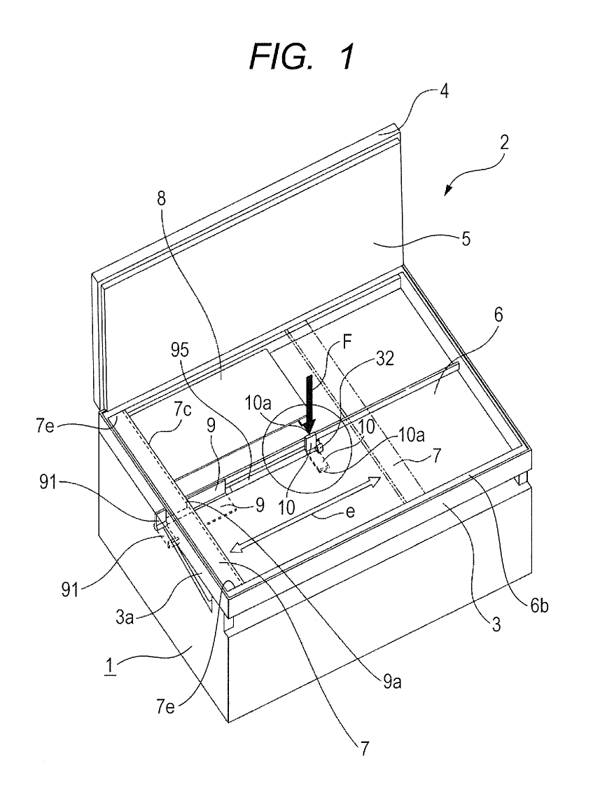

Referring to FIGS. 1 to 5B, an image forming apparatus including an image reading apparatus according to a first embodiment of the present invention is described.

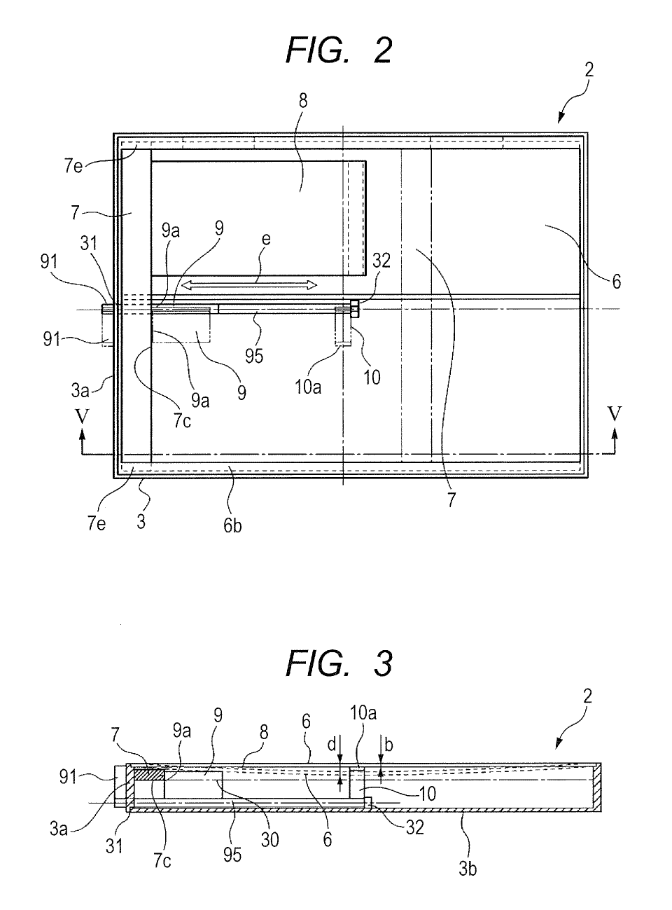

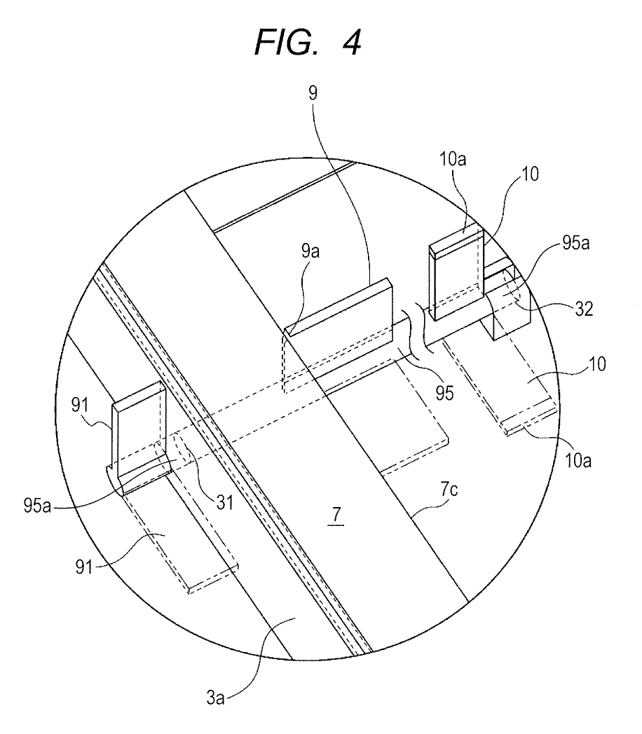

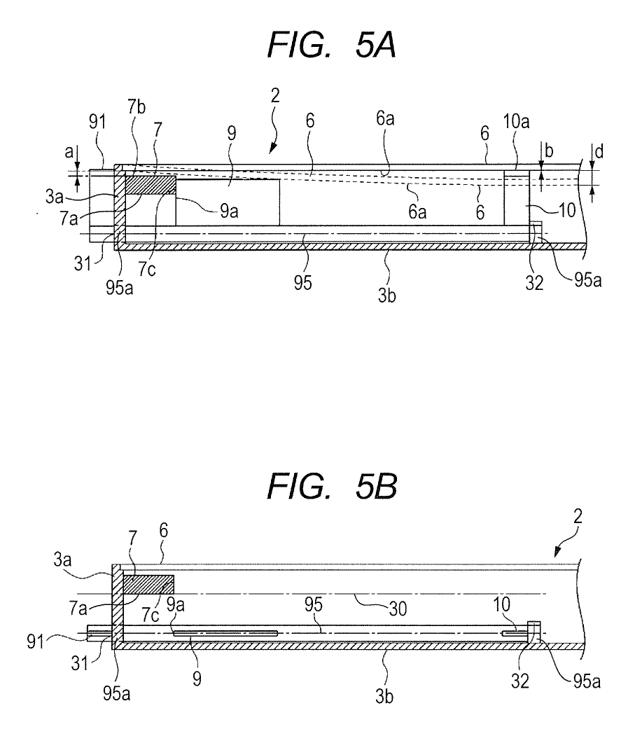

FIG. 1 is a perspective view of a case where an image reading apparatus 2 is arranged above an image forming apparatus 1. FIG. 2 is a plan view of the image reading apparatus alone. FIG. 3 is a sectional view taken along the arrow V-V of FIG. 2. FIG. 4 is an enlarged perspective view for illustrating a main part of a support unit. FIGS. 5A and 5B are enlarged sectional views for illustrating the main part of the support unit. In FIGS. 1 to 5B, the image forming apparatus 1 includes an image forming unit for forming an image on a sheet-like recording material (not shown), such as a paper sheet, based on image information read by the image reading apparatus 2.

The image reading apparatus 2 includes an original placing glass 6 serving as a placing member on which a book (not shown) or a sheet-like original (not shown) is to be placed, a casing 3 for supporting an outer peripheral edge portion 6b of the original placing glass 6, and a cover 4. A pressure plate 5 aligns the original placed on the original placing glass 6 (on the original placing glass) with a surface of the original placing glass (an original placing glass surface). An image sensor section 7 serves as an image reading unit, which is opposed to the original placed on the original placing glass 6 at a position below the original placing glass 6, and is provided so as to be movable along the original placing glass 6 inside the casing 3 (within the casing). Specifically, abutment portions 7e situated at both ends of the image sensor section 7 abut against the casing 3 and are supported movably. The image sensor section 7 includes a light emitting element (not shown) and a light receiving element (not shown). As illustrated in FIG. 1, the original placing glass 6 is a light transmissive member which causes light to pass therethrough. The original (not shown) placed on the original placing glass 6 is irradiated with light from the light emitting element of the image sensor section 7 via the original placing glass 6, and reflection light from the original is received by the light receiving element of the image sensor section 7 via the original placing glass 6 so that the image sensor section 7 reads an image of the original (not shown) placed on the original placing glass 6.

Next, an overview of a reading operation to be performed by the image sensor section 7 is described. In FIGS. 1 and 2, the image sensor section 7 is movable by a drive unit (not shown) such as a motor. The image sensor section 7 is movable in the arrow “e” direction of FIGS. 1 and 2 from a position of a left end portion of the original placing glass 6 of FIGS. 1 and 2, which is also a home position at the time when the image reading apparatus 2 is transported, to a position of the reading operation, which is set in accordance with the size of the original placed on the original placing glass 6.

In FIGS. 1 to 5B, plate-like support members 9 and 10 serve as the support unit for supporting the original placing glass 6 from a lower side thereof by abutting against the lower surface of the original placing glass 6 at a portion other than the portion of the original placing glass 6 which is supported by the casing 3 (outer peripheral edge portion 6b). A signal line bundle 8 is connected to the image sensor section 7.

The support members 9 and 10 of this embodiment include a shaft portion 95, which is rotatably held by a bearing portion 31 provided so as to pass through a side surface 3a of the casing 3 and a bearing portion 32 provided on a bottom surface 3b of the casing 3, and pivot integrally with the shaft portion 95. One end portion of the shaft portion 95 passes through the side surface 3a of the casing 3 and protrudes to an outside, and at the protruding portion, there is provided a tab portion 91 for a pivot operation. When the tab portion 91 is pivoted, the support members 9 and 10 integrally pivot about the shaft portion 95. Accordingly, the support members 9 and 10 are movable between a support position of FIG. 5A for supporting the original placing glass 6 and a retracted position of FIG. 5B retracted from the original placing glass 6. A part of the shaft portion 95 of the support member 9 or 10, which abuts against the bearing portion 31 or the bearing portion 32, corresponds to an abutment portion 95a of the support member 9 or 10, which is supported by the casing 3.

As illustrated in FIG. 5B, the retracted position of the support members 9 and 10 is set as a position at which the support members 9 and 10 do not interfere with the moving operation of the image sensor section 7. In this embodiment, the support members 9 and 10 pivot about the shaft portion 95. At the retracted position of FIG. 5B retracted from the original placing glass 6, the support members 9 and 10 are retracted to a position below a trajectory 30 of movement of a lower surface 7a, which is the lowermost end portion of the image sensor section 7, so that the moving operation of the image sensor section 7 is not hindered (movement of the image sensor section 7 is not restricted). Accordingly, the support members 9 and 10 for supporting the original placing glass 6 are movable to the retracted position below the trajectory 30, which is situated out of the movement trajectory of the image sensor section 7, and hence the image sensor section 7 is not interrupted at the time of the reading operation.

One end portion (left end portion of FIGS. 1 to 5B) 9a of the support member 9 serves also as a restraining unit for restraining the image sensor section 7 at a predetermined position of the left end portion of FIGS. 1 to 5B, which corresponds to the home position, in association with the movement of the support member 9 through the pivot operation. In other words, the one end portion 9a of the support member 9 functions as a restricting member for restricting the movement of the image sensor section 7 from the home position.

As illustrated in FIG. 4, an elastic member 10a is fixed to a tip end portion of the support member 10. When the support member 10 pivots about the shaft portion 95 and is situated at the support position of FIG. 5A for supporting the original placing glass 6, the elastic member 10a abuts against a lower surface 6a of the original placing glass 6 and supports a center portion of the original placing glass 6. The support member 10 supports the center portion of the original placing glass 6, and accordingly a force received by the support member 10 from the lower surface of the original placing glass 6 is transferred via the abutment portions 95a of the shaft portion 95 to the bearing portions 31 and 32 of the casing having a relatively high strength. Therefore, it is possible to restrict flexure of the original placing glass due to a vibration and shock at the time when the apparatus is transported, and thus to prevent damage to the original placing glass 6.

It is assumed that “a” represents a separation distance between an upper surface 7b of the image sensor section 7 and the lower surface 6a of the original placing glass 6, and “b” represents a separation distance between the support member 10 and the lower surface 6a of the original placing glass 6. As illustrated in FIG. 5A, the upper surface 7b of the image sensor section 7 is opposed to the lower surface 6a of the original placing glass 6 at the separation distance “a”. The support member 10 is opposed to the original placing glass 6 at the separation distance “b” that is smaller than the separation distance “a”. The elastic member 10a abuts against the lower surface 6a of the original placing glass 6, and hence FIG. 5A illustrates a case where the separation distance “b” is zero.

The original placing glass 6 indicated by the broken lines of FIG. 5A schematically represents a limit to its shape which keeps the original placing glass 6 from damage thereto. FIG. 5A illustrates a maximum flexure amount “d” of the original placing glass 6 in this case under a state in which the support member 10 is situated at a position (position of the elastic member 10a) abutting against the original placing glass 6 (hereinafter referred to simply as maximum flexure amount “d”). When the separation distance “b” between the support member 10 and the original placing glass 6 is set smaller than the maximum flexure amount “d” of the original placing glass 6, the original placing glass 6 is supported by the support member 10 before the original placing glass 6 is damaged. Thus, when the image reading apparatus 2 is transported under a state illustrated in FIG. 5A, the original placing glass 6 is brought into a state of being supported from an inner side of the casing 3. The original placing glass 6 is not distorted inward due to the vibration and shock at the time of transportation, resulting in a satisfactory holding state. In other words, the support member 10 is set at the support position as illustrated in FIG. 5A when the image reading apparatus 2 is not operated, that is, when the image sensor section 7 is not moved. Accordingly, it is possible to prevent the damage to the original placing glass 6 due to the vibration and shock.

As long as the separation distance “b” between the support member 10 and the original placing glass 6 is smaller than the separation distance “a” between the image sensor section 7 and the original placing glass 6, even when the original placing glass 6 is distorted downward, the original placing glass 6 abuts against the support member 10 and is supported by the support member 10 before the original placing glass 6 comes into contact with the image sensor section 7. Accordingly, even when the original placing glass 6 is distorted downward, the original placing glass 6 does not come into contact with the image sensor section 7, and hence the image sensor section 7 can be protected at the same time as well.

Next, a method of supporting the original placing glass 6 and canceling the support thereof is described with reference to FIGS. 4, 5A, and 5B. The operation of supporting the original placing glass 6 and the operation of canceling the support thereof are switched therebetween by pivoting, about the shaft portion 95, the tab portion 91 that is integrally fixed to the shaft portion 95 and is exposed to the outside from the side surface 3a of the casing 3. As indicated by the solid lines of FIG. 4 and as illustrated in FIG. 5A, the support members 9 and 10 are held upright to be set at the support position for supporting the original placing glass 6. Alternatively, as indicated by the two-dot chain lines of FIG. 4 and as illustrated in FIG. 5B, the support members 9 and 10 are tilted horizontally to be set at the retracted position retracted from the original placing glass 6.

By configuring the tip end portion of the support member 10 with the elastic member 10a, the shock can be absorbed when the original placing glass 6 is distorted downward and comes into contact with the elastic member 10a as illustrated in FIG. 5A, and hence the original placing glass 6 can be protected.

Next, a method of restraining the image sensor section 7 and canceling the restraint thereof is described with reference to FIGS. 4, 5A, and 5B. The operation of restraining the image sensor section 7 and the operation of canceling the restraint thereof are switched therebetween by pivoting, about the shaft portion 95, the tab portion 91 that is integrally fixed to the shaft portion 95 and is exposed to the outside from the side surface 3a of the casing 3.

As indicated by the solid lines of FIG. 4 and as illustrated in FIG. 5A, the support member 9 is held upright. Then, the one end portion 9a of the support member 9 is caused to face a side surface 7c of the image sensor section 7 situated at the left end portion of FIGS. 4, 5A, and 5B, which is the home position of the image sensor section 7, so that the support member 9 is set at a restraining position for restraining the image sensor section 7. Alternatively, as indicated by the two-dot chain lines of FIG. 4 and as illustrated in FIG. 5B, the support member 9 is tilted horizontally to be set at a canceling position (restriction canceling position) for canceling the restraint (restriction) of the image sensor section 7. At this time, the operation of supporting the original placing glass 6 and the operation of canceling the support thereof are performed by the support members 9 and simultaneously with the above-mentioned operations, respectively.

Accordingly, when the image reading apparatus 2 is transported, the original placing glass 6 is supported by the support members 9 and 10, and the image sensor section 7 is restrained and fixed by the support member 9. When the image reading apparatus 2 is operated, the original placing glass 6 and the image sensor section 7 can be released at the same time. In other words, the support member 10 is set at the support position as illustrated in FIG. 5A when the image reading apparatus 2 is not operated, that is, when the image sensor section 7 is not moved, and accordingly the support member 9 is situated at the restraining position at the same time. Therefore, it is possible to prevent the movement of the image sensor section 7 from the predetermined position (home position) due to the vibration and shock.

The bearing portion 31, which is provided at the side surface 3a of the casing 3, and the shaft portion 95 are maintained in a freely slidable, gapless state by a seal member (not shown), and hence dust does not enter the casing 3. As a result, the image reading operation can be performed satisfactorily by the image sensor section 7.

The abutment area of the support members 9 and 10 abutting against the lower surface 6a of the original placing glass 6, and the number of the support members 9 and 10 may be increased as appropriate depending on the area and thickness of the original placing glass 6. For example, the support member 9 may further be extended in an axial direction of the shaft portion 95, and the number of the support members 10 may be increased so that the vicinity of the center of the original placing glass 6 is supported.

The tab portion 91 is pivoted and the support members 9 and 10 move between the support position illustrated in FIG. 5A and the retracted position illustrated in FIG. 5B. At this time, there may arise a need to avoid friction between the support member 10 and the lower surface 6a of the original placing glass 6. In this case, the separation distance “b” between the support member 10 and the original placing glass 6 may be set so as to provide a small gap within the range in which the separation distance “b” is smaller than the separation distance “a” between the image sensor section 7 and the original placing glass 6.

The image sensor section 7 automatically performs a sequence of returning to the left end portion of FIGS. 4, 5A, and 5B as the home position at, for example, a timing at which a user turns OFF the power of the image reading apparatus 2. Accordingly, at the time of transportation, no time and effort is required for moving the image sensor section 7 to the home position, and it is only necessary to pivot the support member 9 to the support position for supporting the original placing glass 6, which is also the restraining position for restraining the image sensor section 7. Accordingly, convenience of the user can be enhanced.

The rigidity of the shaft portion 95 is sufficiently high, and the support member 10 and the bearing portion 32 are situated in proximity in the axial direction. Therefore, when the support member 10 receives the force from the lower surface of the original placing glass 6, the shaft portion 95 that receives the force via the support member 10 is not distorted substantially. Alternatively, when the support member 10 receives the force from the lower surface of the original placing glass 6, the shaft portion 95 may be distorted downward and abut against the bottom surface 3b of the casing 3, to thereby transfer the force to the casing 3. In this case, a lower surface of the shaft portion 95 functions as the abutment portions of the support members 9 and 10. When it is assumed that “c” represents a separation distance between the lower surface of the shaft portion 95 and the bottom surface 3b, and when a relationship of b+c<d is satisfied, the original placing glass 6 is supported through an intermediation of the support member 10 before the original placing glass 6 is damaged. Further, when a relationship of b+c<a is satisfied, even in a case where the original placing glass 6 is distorted downward, the original placing glass 6 does not come into contact with the image sensor section 7, and hence the image sensor section 7 can be protected at the same time as well.

Further, the abutment portions 7e of the image sensor 7 and the abutment portion 95a of the support member 9 are different from each other, and the force transferred from the original placing glass 6 to the support member 9 is not transferred substantially to the image sensor 7, but is transferred to the casing 3 via the abutment portion 95a of the support member 9. Therefore, it is also possible to prevent damage to the image sensor 7.

### Second Embodiment

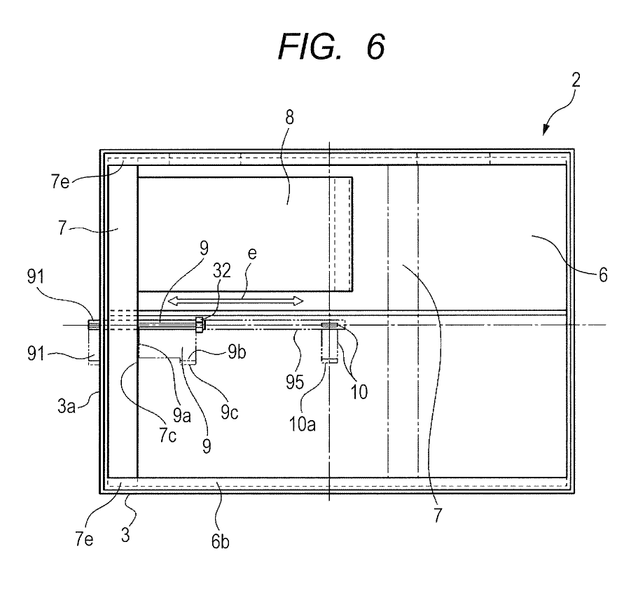

Next, referring to FIG. 6, an image reading apparatus according to a second embodiment of the present invention is described. In the first embodiment, under a state in which the tab portion 91 is pivoted and the support members 9 and 10 are set at the support position illustrated in FIG. 5A, the height of the support member 9 is lower than the height of the support member 10. In this embodiment, as illustrated in FIG. 6, a step portion 9b is provided at a part of the support member 9 so that the support member 9 has the same height as the support member 10. An elastic member 9c is provided at a tip end portion of the step portion 9b. The bearing portion 32 of this embodiment is provided between the support members 9 and 10. Other components are similar to those in the first embodiment, and similar effects can be obtained. With the configuration of this embodiment, the lower surface of the original placing glass 6 is received simultaneously at a plurality of support points, and hence the original placing glass 6 can be supported more firmly.

### Third Embodiment

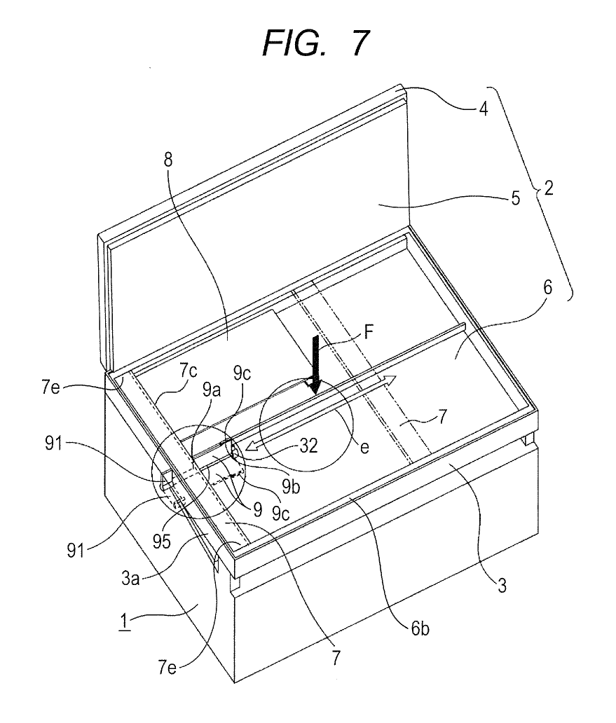

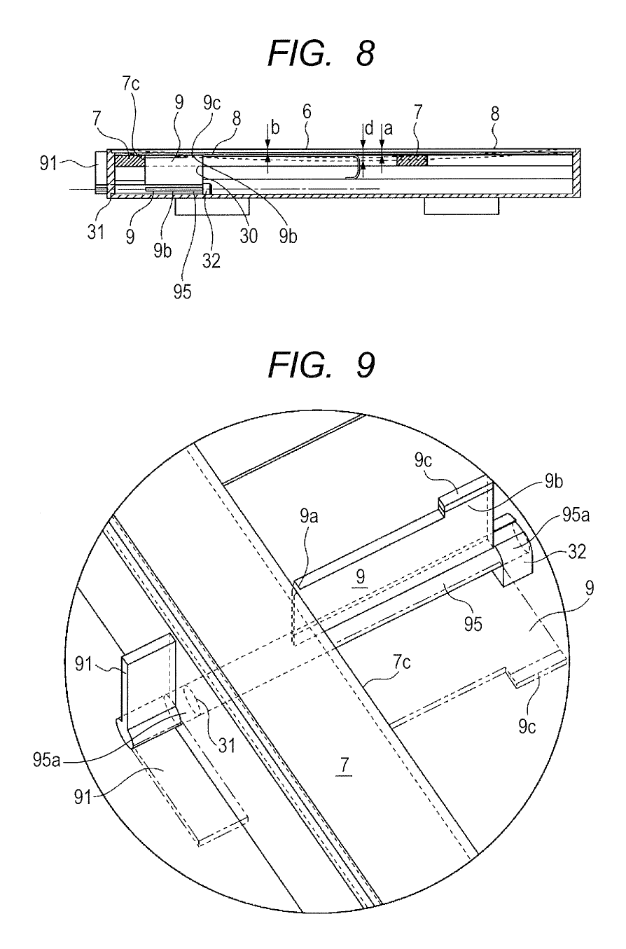

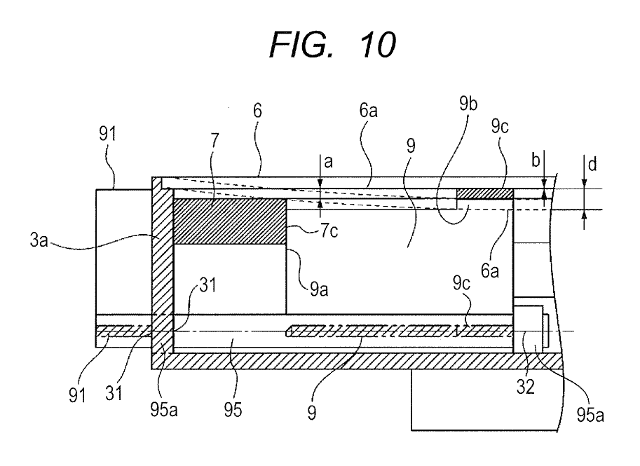

Next, referring to FIGS. 7 to 10, an image forming apparatus including an image reading apparatus according to a third embodiment of the present invention is described. In this embodiment, as illustrated in FIGS. 7, 8, 9, and 10, the support member 10 of the second embodiment is omitted. Other components are similar to those in the first and second embodiments. Also with this configuration, similar effects to those in the first and second embodiments can be obtained. With the configuration of this embodiment, it is possible to support the original placing glass 6 with a simple and less complex configuration, and to prevent the damage to the original placing glass 6 while suppressing increase in cost and weight of the apparatus.

### Fourth Embodiment

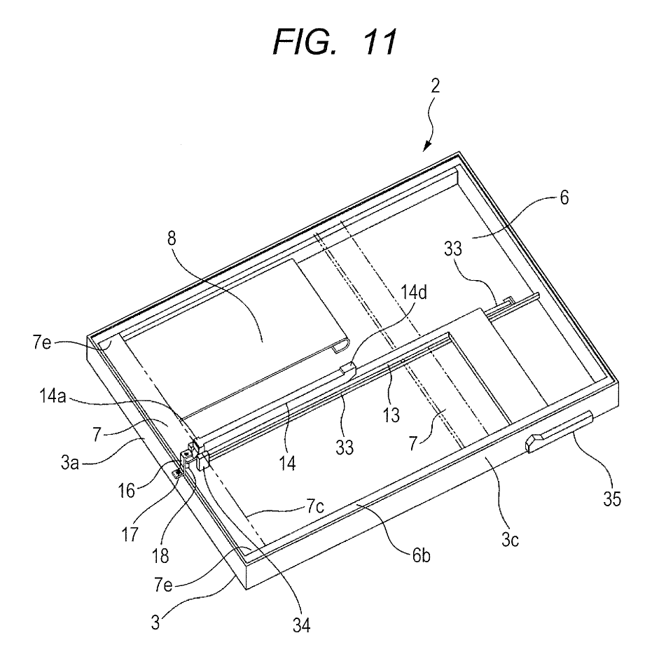

Next, referring to FIGS. 11 to 14B, a configuration of an image reading apparatus according to a fourth embodiment of the present invention is described. In the first to third embodiments, the tab portion 91 is pivoted about the shaft portion 95 to pivot the support members 9 and 10 to the support position and to the retracted position. In this embodiment, a support member 14 serves as the support unit for supporting the original placing glass 6 by abutting against the lower surface 6a of the original placing glass 6 at a portion other than the portion of the original placing glass 6 which is supported by the casing 3, and the support member 14 is raised and lowered inside the casing 3.

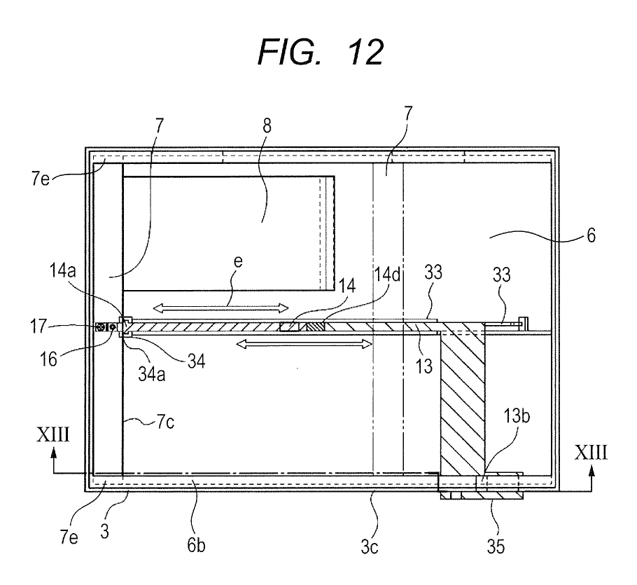

A guide rail 33 is provided at substantially a center portion of the bottom surface 3b of the casing 3 along a moving direction of the image sensor section 7 (lateral direction of FIG. 12). A slider 13 is movable in the lateral direction of FIG. 12 while engaging with the guide rail 33.

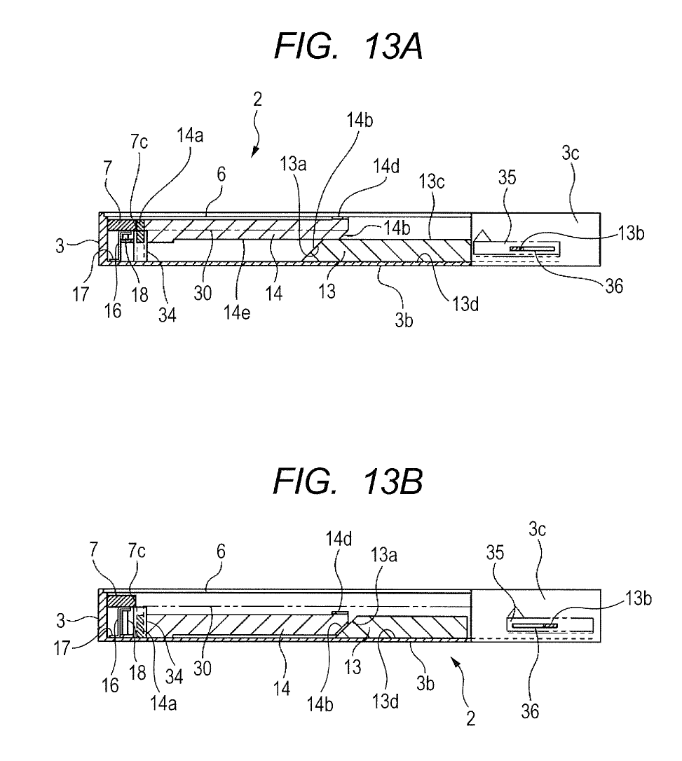

The slider 13 is L-shaped in plain view. A protruding portion 13b having a rectangular prism shape is provided at one end portion of the slider 13, and the protruding portion 13b passes through a long hole 36 formed in a side surface 3c of the casing 3 along a lateral direction of FIGS. 13A and 13B, and protrudes into the outside. A tab portion 35 for a slide operation is provided at the protruding portion 13b. The tab portion 35 is slid along the long hole 36 in the lateral direction of FIGS. 13A and 13B. Accordingly, the slider 13 moves integrally with the tab portion 35 in the lateral direction of FIGS. 12, 13A, and 13B while engaging with the guide rail 33. An inclined surface 13a is provided at another end portion of the slider 13 which is opposed to the support member 14.

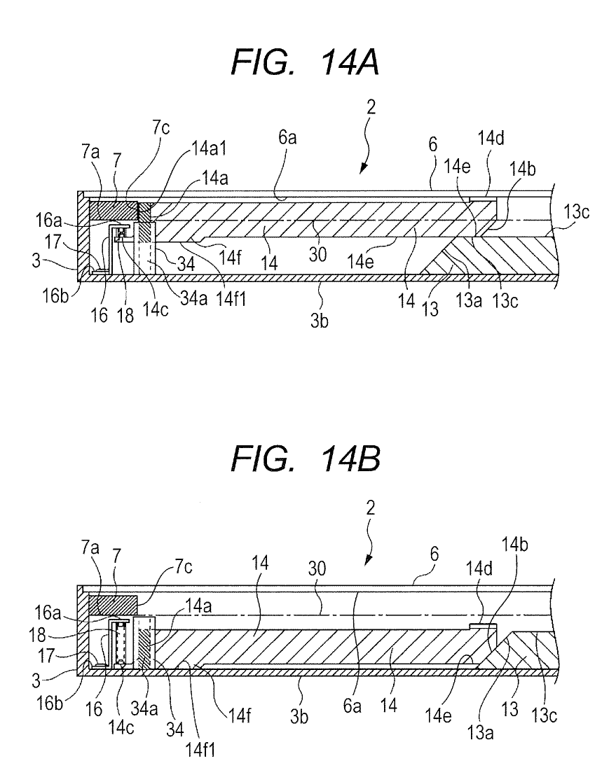

A pair of opposing guide rails 34 having a C-shaped cross section is provided upright in a vertical direction of FIGS. 13A, 13B, 14A, and 14B at a position on the bottom surface 3b of the casing 3 and on an extension line of the guide rail 33. A fitting portion 14a having a T-shaped cross section is provided at one end portion of the support member 14, and the fitting portion 14a is fitted in a guide rail 34a of the guide rails 34 so that the fitting portion 14a can be raised and lowered along the guide rail 34a. An inclined surface 14b corresponding to the inclined surface 13a of the slider 13 is provided at another end portion of the support member 14. An elastic member 14d, which abuts against the lower surface 6a of the original placing glass 6 and supports the original placing glass 6, is provided above the inclined surface 14b.

A spring-supported portion 14c is provided at a tip end portion of the fitting portion 14a, which is provided at the one end portion of the support member 14. A lower piece 16b of a pressurization bracket 16 having a Z-shaped cross section is fixed with a screw 17 on the bottom surface 3b of the casing 3. A coil-like pressurization spring 18 is locked between an upper piece 16a of the pressurization bracket 16 and the spring-supported portion 14c of the support member 14. The support member 14 is constantly biased in a downward direction of FIGS. 14A and 14B by an elastic force of the pressurization spring 18.

FIGS. 13A and 14A illustrate a positional relationship of the respective components at the time when the image reading apparatus 2 is transported. The support member 14 is raised to be set at the support position for supporting the original placing glass 6, and the lower surface 6a of the original placing glass 6 is supported by the elastic member 14d of the support member 14. A side surface 14a1 of the fitting portion 14a of the support member 14 faces the side surface 7c of the image sensor section 7 situated at the home position, and accordingly the image sensor section 7 is held in a state of being restrained.

FIGS. 13B and 14B illustrate a positional relationship of the respective components at the time when the image reading apparatus 2 performs the reading operation. The support member 14 is lowered to be set at the retracted position retracted from the original placing glass 6, and the original placing glass 6 and the image sensor section 7 are held in a state in which the support and restraint thereof are canceled.

As illustrated in FIG. 13B, under a state in which the support member 14 is lowered to be set at the retracted position retracted from the original placing glass 6, the inclined surface 14b of the support member 14 slidably abuts against the inclined surface 13a of the slider 13. Then, the tab portion 35 coupled to the slider 13 is slid on an outer side of the side surface 3c of the casing 3 along the long hole 36 in a leftward direction of FIGS. 13A and 13B. Accordingly, the slider 13 moves integrally with the tab portion 35 in the leftward direction of FIGS. 13A and 13B while engaging with the guide rail 33.

Then, the inclined surface 14b of the support member 14 slides in abutment against the inclined surface 13a of the slider 13, and in this state, the support member 14 is raised along the guide rails 34 against the biasing force of the pressurization spring 18. Then, as illustrated in FIG. 13A, a lower surface 14e of the support member 14 is placed on an upper surface 13c of the slider 13, and the support member 14 is set at the support position for supporting the center portion of the lower surface 6a of the original placing glass 6. At this time, the support member 14 and the slider 13 may be regarded collectively as a support member capable of supporting the original placing glass 6, and at this time, a lower surface 13d of the slider 13 functions as an abutment surface at which the support member abuts against the casing 3 and is supported by the casing 3.

The support member 14 is movable at a predetermined separation distance between the support member 14 and the lower surface 6a of the original placing glass 6. As illustrated in FIG. 13A, the support member 14 is raised to be set at the support position for supporting the lower surface 6a of the original placing glass 6. When the support member 14 is raised along the guide rails 34, the elastic member 14d abuts against the lower surface 6a of the original placing glass 6 in a normal direction to the lower surface 6a. Therefore, the elastic member 14d can be caused to abut against the lower surface 6a of the original placing glass 6 more smoothly as compared to the first embodiment, in which the elastic member 10a abuts against the lower surface 6a while moving in a direction substantially parallel to the lower surface 6a, and thus a load on the user can be reduced.

The side surface 14a1 of the fitting portion 14a provided at the one end portion of the support member 14, which protrudes from upper end portions of the guide rails 34, is caused to face the side surface 7c of the image sensor section 7 situated at the left end portion of FIGS. 12 to 14B, to thereby restrain the image sensor section 7. The left end portion of FIGS. 12 to 14B corresponds to the home position of the image sensor section 7.

The fitting portion 14a provided at the one end portion of the support member 14 serves also as the restraining unit for restraining the image sensor section 7 at the home position in association with the movement of the support member 14.

When the tab portion 35 coupled to the slider 13 is slid on the outer side of the side surface 3c of the casing 3 along the long hole 36 in a rightward direction of FIGS. 13A and 13B, the slider 13 moves integrally with the tab portion 35 in the rightward direction of FIGS. 13A and 13B while engaging with the guide rail 33. Then, under the state illustrated in FIG. 14A, the upper surface 13c of the slider 13 moves in a rightward direction of FIGS. 14A and 14B while sliding along the lower surface 14e of the support member 14.

Then, the inclined surface 13a of the slider 13 and the inclined surface 14b of the support member 14 slide in abutment against each other. The inclined surface 14b of the support member 14 slides in abutment against the inclined surface 13a of the slider 13, and in this state, the support member 14 is lowered along the guide rails 34 by a self-weight thereof and the biasing force of the pressurization spring 18. Then, as illustrated in FIG. 14B, a lower surface 14f1 of a step portion 14f provided on the one end portion side of the support member 14 abuts against the bottom surface 3b of the casing 3 so that the support member 14 is set at the retracted position retracted from the original placing glass 6.

When the support member 14 is lowered to be set at the retracted position of FIGS. 13B and 14B retracted from the original placing glass 6, the support member 14 is retracted to a position below the trajectory 30 of the movement of the lower surface 7a, which is the lowermost end portion of the image sensor section 7. Accordingly, the moving operation of the image sensor section 7 is not hindered. The support member 14 for supporting the original placing glass 6 is movable to the retracted position below the trajectory 30, which is situated out of the movement trajectory of the image sensor section 7, and hence the image sensor section 7 is not interrupted at the time of the reading operation. Other components are similar to those in the above-mentioned embodiments, and similar effects can be obtained. Further, as in this embodiment, the elastic member abuts against the lower surface of the original placing glass in the normal direction to the lower surface. Accordingly, the elastic member can be caused to abut against the lower surface of the original placing glass more smoothly as compared to the first embodiment, and thus the load on the user can be reduced.

### Fifth Embodiment

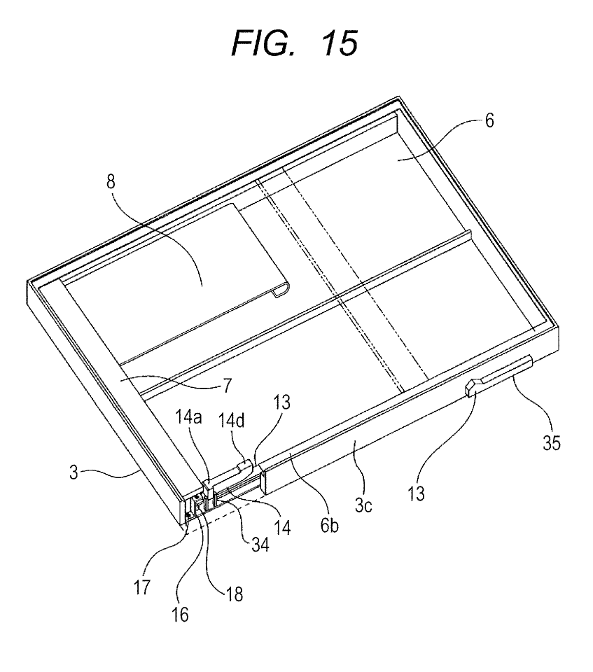

Next, referring to FIGS. 15 to 18, a configuration of an image reading apparatus according to a fifth embodiment of the present invention is described. In the fourth embodiment, the elastic member 14d of the support member 14 is arranged at a position of substantially the center portion of the lower surface 6a of the original placing glass 6. In this embodiment, the elastic member 14d of the support member 14 is arranged at a position in the vicinity of the home position of the image sensor section 7 in the lower surface 6a of the original placing glass 6 and in the vicinity of the side surface 3c on which the tab portion 35 is provided.

The guide rail 33 is provided on the bottom surface 3b of the casing 3 and in the vicinity of the side surface 3c thereof along a moving direction of the image sensor section 7 (lateral direction of FIG. 16). The elongated slider 13 is movable in the lateral direction of FIG. 16 while engaging with the guide rail 33.

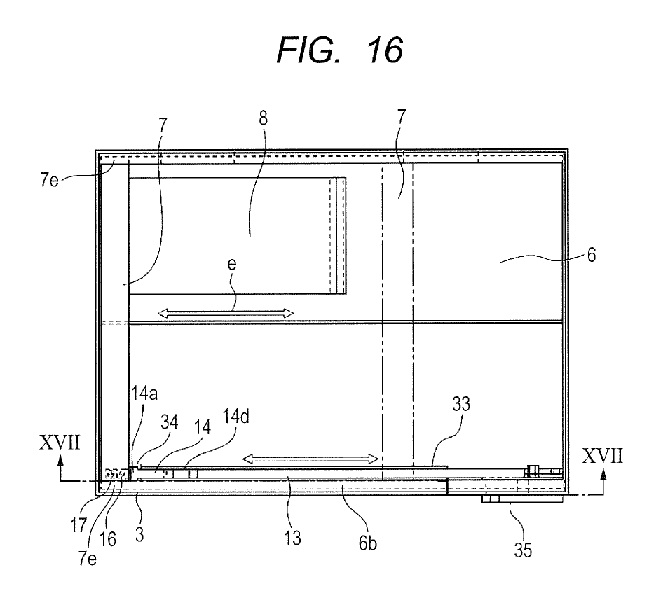

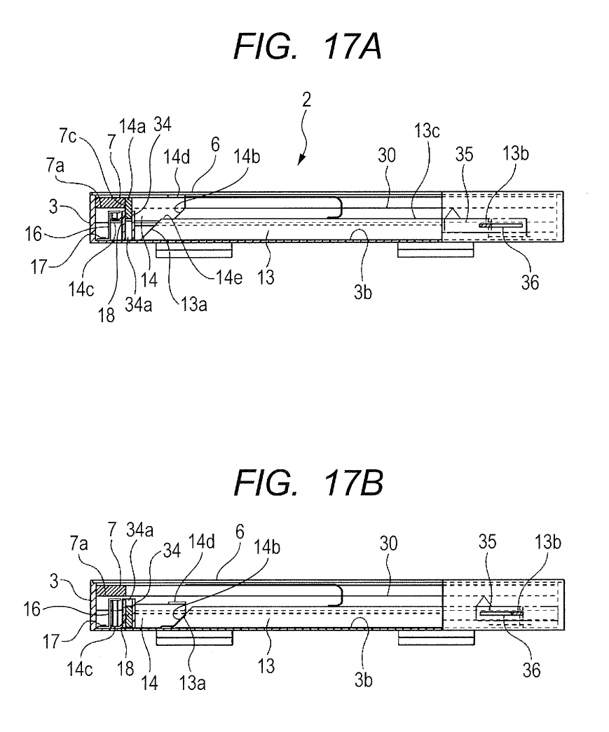

The slider 13 is L-shaped in a plain view. The protruding portion 13b having a rectangular prism shape is provided at the one end portion of the slider 13, and this protruding portion 13b passes through the long hole 36 formed in the side surface 3c of the casing 3 along a lateral direction of FIGS. 17A and 17B, and protrudes to the outside. The tab portion 35 for a slide operation is provided at the protruding portion 13b. The tab portion 35 is slid along the long hole 36 in the lateral direction of FIGS. 17A and 17B, and accordingly the slider 13 moves integrally with the tab portion 35 in the lateral direction of FIGS. 16, 17A, and 17B while engaging with the guide rail 33. The inclined surface 13a is provided at the other end portion of the slider 13 which is opposed to the support member 14.

The guide rail 34 having a C-shaped cross section is provided upright at a position on the bottom surface 3b of the casing 3 and on the extension line of the guide rail 33. The fitting portion 14a having a T-shaped cross section is provided at the one end portion of the support member 14, and the fitting portion 14a is fitted in the guide rail 34a of the guide rail 34 so that the fitting portion 14a can be raised and lowered along the guide rail 34a. The inclined surface 14b corresponding to the inclined surface 13a of the slider 13 is provided at the other end portion of the support member 14. The elastic member 14d, which abuts against the lower surface 6a of the original placing glass 6 and supports the original placing glass 6, is provided above the inclined surface 14b.

The spring-supported portion 14c is provided at a tip end portion of the fitting portion 14a, which is provided at the one end portion of the support member 14. The lower piece 16b of the pressurization bracket 16 having a Z-shaped cross section is fixed with the screw 17 on the bottom surface 3b of the casing 3. The coil-like pressurization spring 18 is locked between the upper piece 16a of the pressurization bracket 16 and the spring-supported portion 14c of the support member 14. The support member 14 is constantly biased in a downward direction of FIG. 17B by an elastic force of the pressurization spring 18.

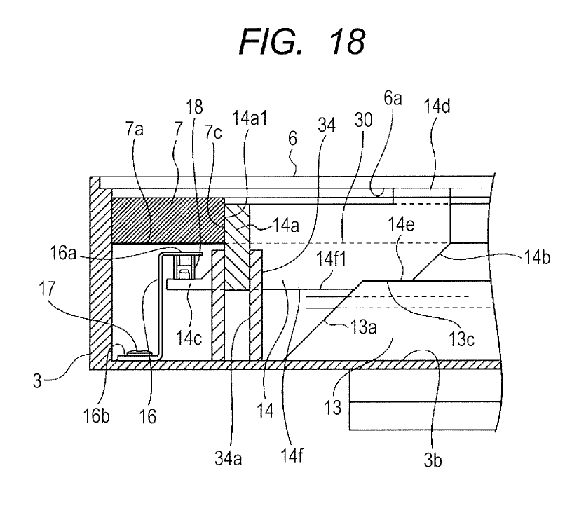

FIGS. 17A and 18 illustrate a positional relationship of the respective components at the time when the image reading apparatus 2 is transported. The support member 14 is raised to be set at the support position for supporting the original placing glass 6, and the lower surface 6a of the original placing glass 6 is supported by the elastic member 14d of the support member 14. The side surface 14a1 of the fitting portion 14a of the support member 14 faces the side surface 7c of the image sensor section 7 situated at the home position, and accordingly the image sensor section 7 is held in a state of being restrained.

FIG. 17B illustrates a positional relationship of the respective components at the time when the image reading apparatus 2 performs the reading operation. The support member 14 is lowered to be set at the retracted position retracted from the original placing glass 6, and the original placing glass 6 and the image sensor section 7 are held in a state in which the support and restraint thereof are canceled.

As illustrated in FIG. 17B, under a state in which the support member 14 is lowered to be set at the retracted position retracted from the original placing glass 6, the inclined surface 14b of the support member 14 slidably abuts against the inclined surface 13a of the slider 13. Then, the tab portion 35 coupled to the slider 13 is slid on an outer side of the side surface 3c of the casing 3 along the long hole 36 in a leftward direction of FIGS. 17A and 17B. Accordingly, the slider 13 moves integrally with the tab portion 35 in the leftward direction of FIGS. 17A and 17B while engaging with the guide rail 33.

Then, the inclined surface 14b of the support member 14 slides in abutment against the inclined surface 13a of the slider 13, and in this state, the support member 14 is raised along the guide rail 34 against the biasing force of the pressurization spring 18. Then, as illustrated in FIGS. 17A and 18, the lower surface 14e of the support member 14 is placed on the upper surface 13c of the slider 13, and the support member 14 is set at the support position for supporting the lower surface 6a of the original placing glass 6.

The support member 14 is movable at a predetermined separation distance between the support member 14 and the lower surface 6a of the original placing glass 6. As illustrated in FIGS. 17A and 18, the support member 14 is raised to be set at the support position for supporting the lower surface 6a of the original placing glass 6.

Then, the side surface 14a1 of the fitting portion 14a provided at the one end portion of the support member 14, which protrudes from the upper end portion of the guide rail 34, is caused to face the side surface 7c of the image sensor section 7 situated at the left end portion of FIGS. 17A, 17B, and 18, to thereby restrain the image sensor section 7. The left end portion of FIGS. 17A, 17B, and 18 corresponds to the home position of the image sensor section 7.

The fitting portion 14a provided at the one end portion of the support member 14 serves also as the restraining unit for restraining the image sensor section 7 at the home position in association with the movement of the support member 14.

When the tab portion 35 coupled to the slider 13 is slid on the outer side of the side surface 3c of the casing 3 along the long hole 36 in a rightward direction of FIG. 17B, the slider 13 moves integrally with the tab portion 35 in the rightward direction of FIG. 17B while engaging with the guide rail 33.

Then, under the state illustrated in FIG. 18, the upper surface 13c of the slider 13 moves in a rightward direction of FIG. 17B while sliding along the lower surface 14e of the support member 14, and the inclined surface 13a of the slider 13 slides in abutment against the inclined surface 14b of the support member 14. The inclined surface 14b of the support member 14 slides in abutment against the inclined surface 13a of the slider 13, and in this state, the support member 14 is lowered along the guide rail 34 by the self-weight thereof and the biasing force of the pressurization spring 18. Then, as illustrated in FIG. 17B, the lower surface 14f1 of the step portion 14f provided on the one end portion side of the support member 14 abuts against the bottom surface 3b of the casing 3 so that the support member 14 is set at the retracted position retracted from the original placing glass 6.

When the support member 14 is lowered to be set at the retracted position of FIG. 17B retracted from the original placing glass 6, the support member 14 is retracted to a position below the trajectory 30 of the movement of the lower surface 7a, which is the lowermost end portion of the image sensor section 7. Accordingly, the moving operation of the image sensor section 7 is not hindered. The support member 14 for supporting the original placing glass 6 is movable to the retracted position below the trajectory 30, which is situated out of the movement trajectory of the image sensor section 7, and hence the image sensor section 7 is not interrupted at the time of the reading operation. Other components are similar to those in the above-mentioned embodiments, and similar effects can be obtained. In this embodiment, the elastic member abuts against the lower surface of the original placing glass in the normal direction to the lower surface. Thus, similarly to the fourth embodiment, the elastic member can be caused to abut against the lower surface of the original placing glass more smoothly as compared to the first embodiment, and thus the load on the user can be reduced.

### Sixth Embodiment

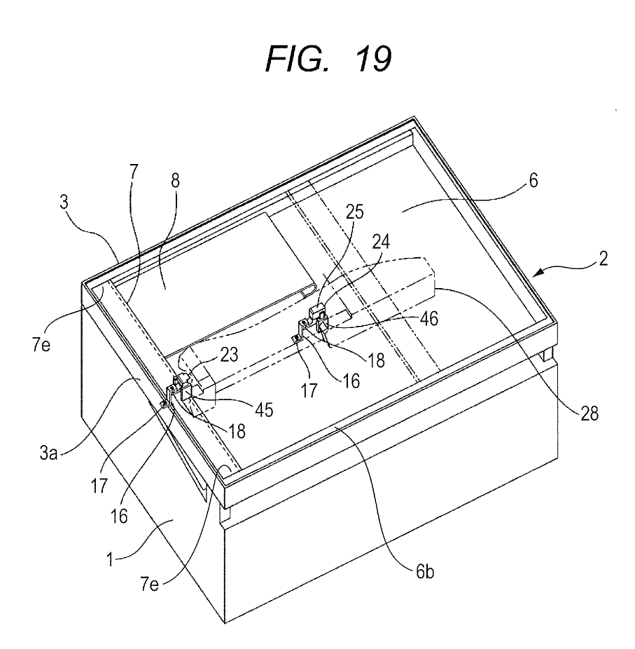

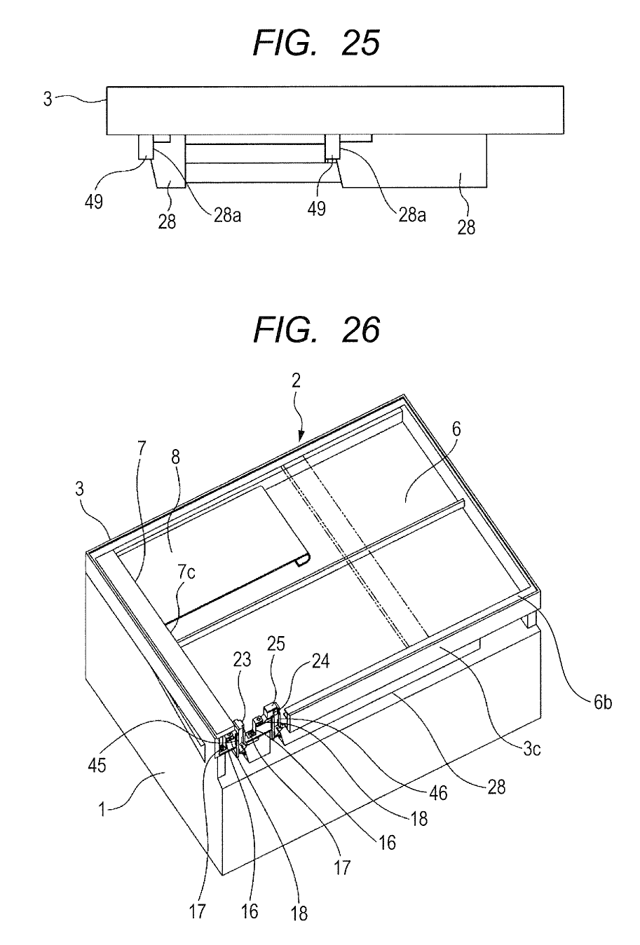

Next, referring to FIGS. 19 to 25, a configuration of an image reading apparatus according to a sixth embodiment of the present invention is described. In the first to fourth embodiments, the tab portions 91 and 35 for operating the support members 9 and 14 are provided on the outer side of the side surfaces 3a and 3c of the casing 3, respectively.

In this embodiment, the image reading apparatus 2 is transported under a state in which a packaging material is set. In association with a user's operation of placing the packaging material 28 onto the image reading apparatus 2 at the time of packaging work, a support member 24 serving as the support unit supports the lower surface 6a of the original placing glass 6 at a portion other than the portion of the original placing glass 6 which is supported by the casing 3. Further, in association with a user's operation of removing the packaging material 28 from the image reading apparatus 2 at the time of unpackaging work, the support of the lower surface 6a of the original placing glass 6 is canceled.

The support member 24 is movable between the support position for supporting the lower surface 6a of the original placing glass 6 and the retracted position retracted from the lower surface 6a of the original placing glass 6.

In association with the operation of placing and removing the packaging material 28, a restraining member 23 serving as the restraining unit is movable between the restraining position for restraining the image sensor section 7 at the home position and the canceling position for canceling the restraint of the image sensor section 7.

In this embodiment, the restraining member 23 and the support member 24 are provided separately. The restraining member 23 is arranged in the vicinity of the home position of the image sensor section 7 and at substantially a center portion of the image sensor section 7 in its longitudinal direction. An elastic member 25 of the support member 24 is arranged at a position of substantially the center portion of the lower surface 6a of the original placing glass 6.

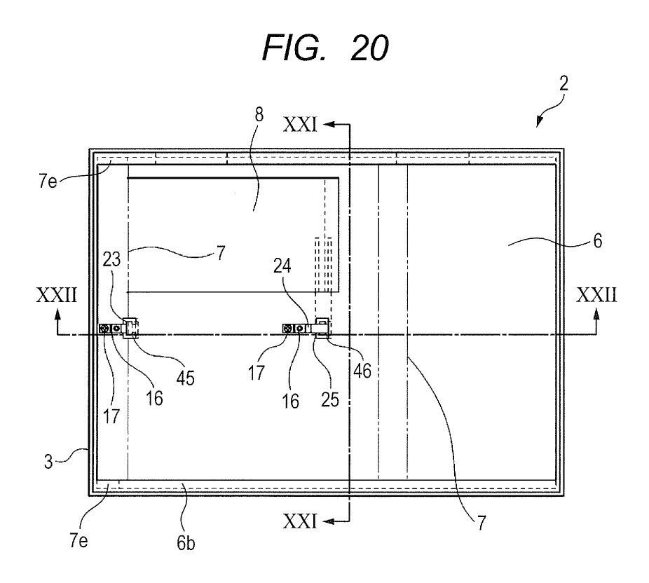

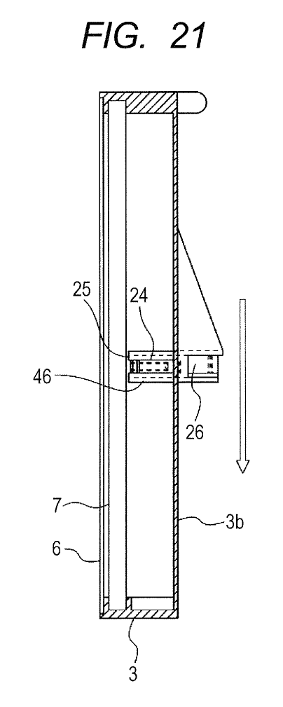

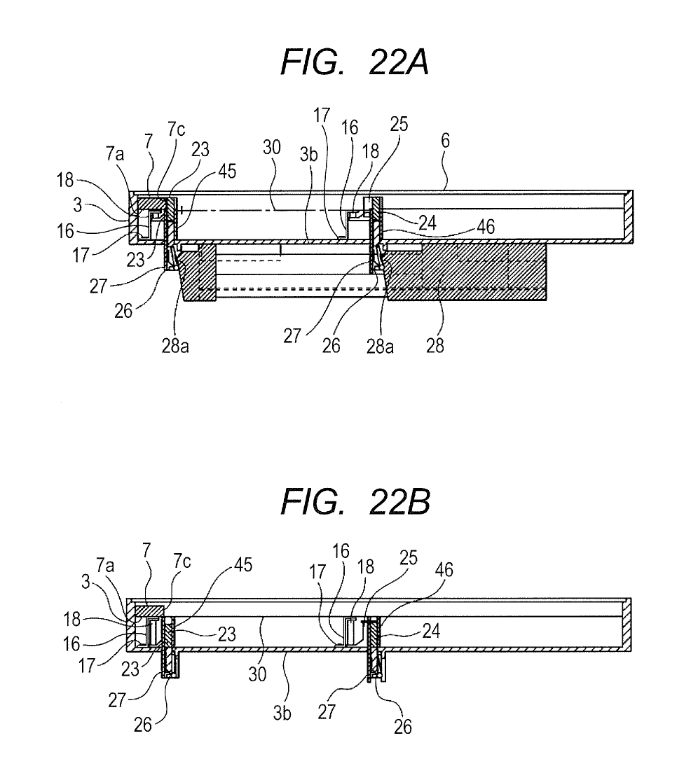

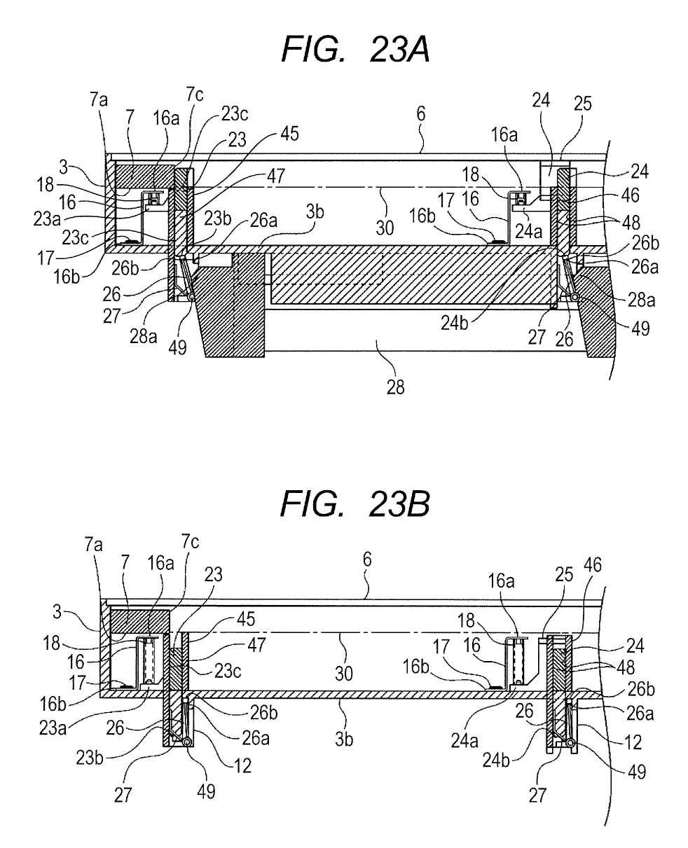

As illustrated in FIGS. 20 and 21, guide rails 45 and guide rails 46 are provided upright in a vertical direction of FIGS. 22A, 22B, 23A, and 23B at positions on the bottom surface 3b of the casing 3. The guide rails 45 are provided in the vicinity of the home position at the left end portion illustrated in FIG. 20, and the guide rails 46 are provided at the center portion of the bottom surface 3b illustrated in FIG. 20. The guide rails 45 are formed of a pair of opposing rail members having a C-shaped cross section and serving as guide rails 47, which pass through the bottom surface 3b of the casing 3 and communicate the inner side and the outer side of the casing 3. The guide rails 46 are formed of a pair of opposing rail members having a C-shaped cross section and serving as guide rails 48, which pass through the bottom surface 3b of the casing 3 and communicate the inner side and the outer side of the casing 3.

The guide rails 45 for guiding the restraining member 23 so that the restraining member 23 can be raised and lowered are arranged in the vicinity of the home position of the image sensor section 7 and at substantially the center portion of the image sensor section 7 in its longitudinal direction. The guide rails 46 for guiding the support member 24 so that the support member 24 can be raised and lowered are arranged at a position of substantially the center portion of the lower surface 6a of the original placing glass 6.

In the guide rails 47, the restraining member 23 having a T-shaped cross section, which is movable along the guide rails 45 in the vertical direction of FIGS. 22A, 22B, 23A, and 23B while engaging with the guide rails 47, is fitted along the guide rails 47 so that the restraining member 23 can be raised and lowered. Similarly, in the guide rails 48, the support member 24 having a T-shaped cross section, which is movable along the guide rails 46 in the vertical direction of FIGS. 22A, 22B, 23A, and 23B while engaging with the guide rails 48, is fitted along the guide rails 48 so that the support member 24 can be raised and lowered.

In this embodiment, the guide rails 45 for holding the restraining member 23 so that the restraining member 23 can be raised and lowered are provided on the left end portion side of FIGS. 22A, 22B, 23A, and 23B, which corresponds to the home position of the image sensor section 7. The guide rails 46 for holding the support member 24 so that the support member 24 can be raised and lowered are provided at the position of substantially the center portion of the lower surface 6a of the original placing glass 6. The elastic member 25, which abuts against the lower surface 6a of the original placing glass 6 and supports the original placing glass 6, is provided at an upper portion of the support member 24.

A spring-supported portion 23a protruding from the guide rails 45 is provided at an intermediate portion of the restraining member 23 in the vertical direction. A spring-supported portion 24a protruding from the guide rails 46 is provided at an intermediate portion of the support member 24 in the vertical direction.

The lower pieces 16b of the pressurization brackets 16 each having a Z-shaped cross section are fixed with the screws 17, respectively, on the bottom surface 3b of the casing 3. The coil-like pressurization springs 18 are locked between the spring-supported portion 23a of the restraining member 23 and the upper piece 16a of the corresponding pressurization bracket 16, and between the spring-supported portion 24a of the support member 24 and the upper piece 16a of the corresponding pressurization bracket 16.

The restraining member 23 and the support member 24 are constantly biased in a downward direction of FIGS. 22A, 22B, 23A, and 23B by the elastic forces of the respective pressurization springs 18.

A rocker arm 26 having an L-shaped cross section and pivotable about a support shaft 49 is provided at a lower end portion of each of the guide rails 45 and the guide rails 46 protruding from the bottom surface 3b of the casing 3 to the outside. A torsion coil spring 27 fitted onto the support shaft 49 is provided on a side surface of each rocker arm 26. One end portion of the torsion coil spring 27 is locked at a locking portion 26a provided on the side surface of the rocker arm 26. Another end portion of the torsion coil spring 27 abuts against one inner wall surface of each of the guide rails 45 and the guide rails 46.

The rocker arm 26 is constantly biased about the support shaft 49 in a clockwise direction of FIGS. 23A and 23B by an elastic force of the torsion coil spring 27. Therefore, under a state in which the packaging material 28 is placed through an opening portion 12 provided at a part of the inner wall surface of each of the guide rails 45 and the guide rails 46, as illustrated in FIG. 23A, a long piece of the rocker arm 26 abuts against a wall surface 28a of the packaging material 28 and is held in a stationary state.

A procedure of canceling the restraining state of the image sensor section 7 and the holding of the original placing glass 6 is described. Under a state in which the packaging material 28 is removed, as illustrated in FIG. 23B, the biasing force of the torsion coil spring 27 is set sufficiently large against frictional resistance occurring between a top surface 26b of the rocker arm 26 and a lower end portion 23b of the restraining member 23. Therefore, the rocker arm 26 pivots until the long piece of the rocker arm 26 strikes another inner wall surface of the guide rails 45. Similarly, the biasing force of the torsion coil spring 27 is set sufficiently large against frictional resistance occurring between the top surface 26b of the rocker arm 26 and a lower end portion 24b of the support member 24. Therefore, the rocker arm 26 pivots until the long piece of the rocker arm 26 strikes another inner wall surface of the guide rails 46.

In the manner described above, the locking state of the restraining member 23 and the support member 24 is canceled, and the restraining member 23 and the support member 24 are lowered along the guide rails 45 and the guide rails 46, respectively. Through the above-mentioned series of operations, the restraining state of the image sensor section 7 and the holding of the original placing glass 6 are canceled.

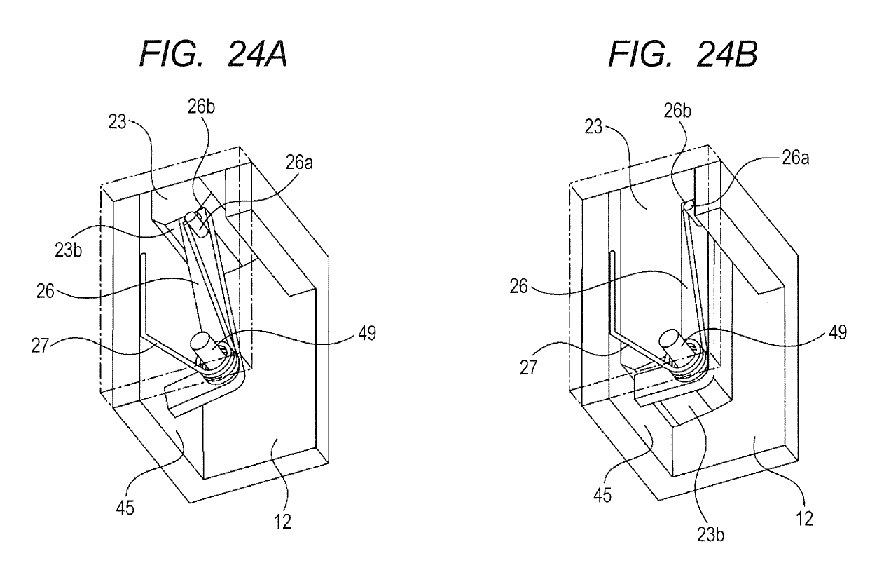

A procedure of setting the image sensor section 7 into the restraining state and holding the original placing glass 6 is described. FIGS. 24A and 24B are partially enlarged perspective views of FIGS. 22A and 22B, respectively. In FIGS. 24A and 24B, the wall on the front side of the drawing sheet is indicated by the chain lines so that the inner structure is visible. In FIGS. 24A and 24B, the opening portion 12 is formed at a part of the inner wall surface of each of the guide rails 45 and the guide rails 46, against which the long piece of the rocker arm 26 abuts. A finger (not shown) is inserted through the opening portion 12, and the restraining member 23 is raised along the guide rails 45 against the biasing force of the pressurization spring 18. Further, the rocker arm 26 is pivoted about the support shaft 49 in a counterclockwise direction of FIG. 23A against the biasing force of the torsion coil spring 27. Then, at a position at which the top surface 26b of the rocker arm 26 strikes the lower end portion 23b of the restraining member 23, the rocker arm 26 is temporarily held with the finger. Subsequently, the packaging material 28 is replaced for the finger and inserted through the opening portion so that the wall surface 28a supports the rocker arm 26 against the biasing force of the torsion coil spring. Subsequently, a finger (not shown) is inserted through the opening portion 12 of the guide rails 46, and the support member 24 is raised along the guide rails 46 against the biasing force of the pressurization spring 18. Further, the rocker arm 26 is pivoted about the support shaft 49 in the counterclockwise direction of FIG. 23A against the biasing force of the torsion coil spring 27. Then, at a position at which the top surface 26b of the rocker arm 26 strikes the lower end portion 24b of the support member 24, the rocker arm 26 is temporarily held with the finger. Subsequently, the packaging material 28 is replaced for the finger and inserted through the opening portion so that the wall surface 28a supports the rocker arm 26 against the biasing force of the torsion coil spring. In this state, the rocker arm 26 may be regarded as a part of the casing 3, and the lower end portion 24b of the support member 24 functions as an abutment surface of the support member 24 which is supported by the casing 3.

When setting the image sensor section 7 into the restraining state and holding the original placing glass 6, it is assumed that the image sensor section 7 is moved in advance to the home position thereof.

At the time of unpackaging, the holding state of the image sensor section 7 and the original placing glass 6 can be canceled by only removing the packaging material 28. Therefore, such an operation is easy for the user, and further, packaging can be performed again.

As shown in FIG. 23B, the restraining member 23 and the support member 24 are lowered to be set at the retracted positions retracted from the image sensor section 7 and the original placing glass 6, respectively. In this case, the restraining member 23 and the support member 24 are retracted to positions below the trajectory 30 of the movement of the lower surface 7a, which is the lowermost end portion of the image sensor section 7. Accordingly, the moving operation of the image sensor section 7 is not hindered.

Accordingly, the restraining member 23 for restraining the image sensor section 7 at the home position and the support member 24 for supporting the original placing glass 6 are movable to the retracted positions below the trajectory 30, which are situated out of the movement trajectory of the image sensor section 7, and hence the image sensor section 7 is not interrupted at the time of the reading operation.

In this embodiment, the packaging material 28 restricts the rocker arm 26 to indirectly perform the operation of raising and lowering the restraining member 23 for restraining the image sensor section 7 and the support member 24 for supporting the lower surface 6a of the original placing glass 6. Alternatively, the rocker arm 26 may be omitted and a part of the packaging material 28 may directly abut against the restraining member 23 for restraining the image sensor section 7 and the support member 24 for supporting the lower surface 6a of the original placing glass 6, to thereby perform the operation of raising and lowering the restraining member 23 and the support member 24. Other components are similar to those in the above-mentioned embodiments, and similar effects can be obtained. According to this embodiment, at the time of unpackaging, the holding state of the original placing glass 6 and the restraining state of the image sensor section 7 can be canceled by only removing the packaging material. Therefore, the user does not need to carry out the canceling operation separately from the operation of removing the packaging material, and hence the usability is improved.

### Seventh Embodiment

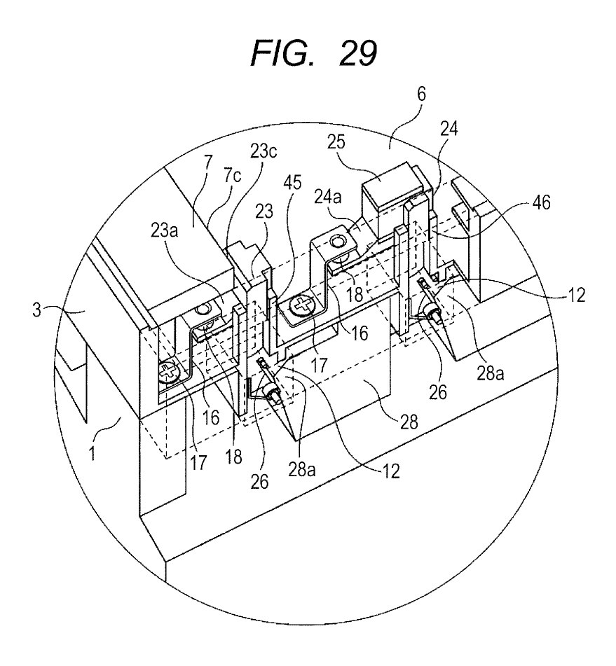

Next, referring to FIGS. 26 to 30, a configuration of an image reading apparatus according to a seventh embodiment of the present invention is described. In the sixth embodiment, the restraining member 23 is arranged in the vicinity of the home position of the image sensor section 7 and at substantially the center portion of the image sensor section 7 in its longitudinal direction. Further, the elastic member 25 of the support member 24 is arranged at the position of substantially the center portion of the lower surface 6a of the original placing glass 6.

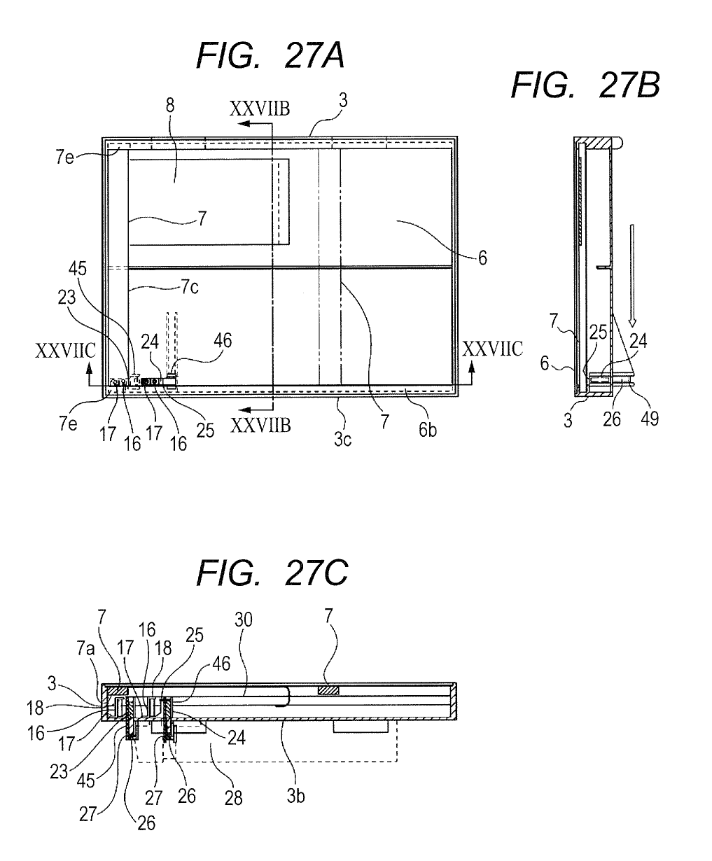

In this embodiment, as illustrated in FIGS. 26 to 27C, the restraining member 23 is arranged in the vicinity of the home position of the image sensor section 7 and in the vicinity of the side surface 3c of the casing 3. The elastic member 25 of the support member 24 is arranged within the range of the lower surface 6a of the original placing glass 6 at a position in the vicinity of the side surface 3c of the casing 3 and in proximity to the restraining member 23.

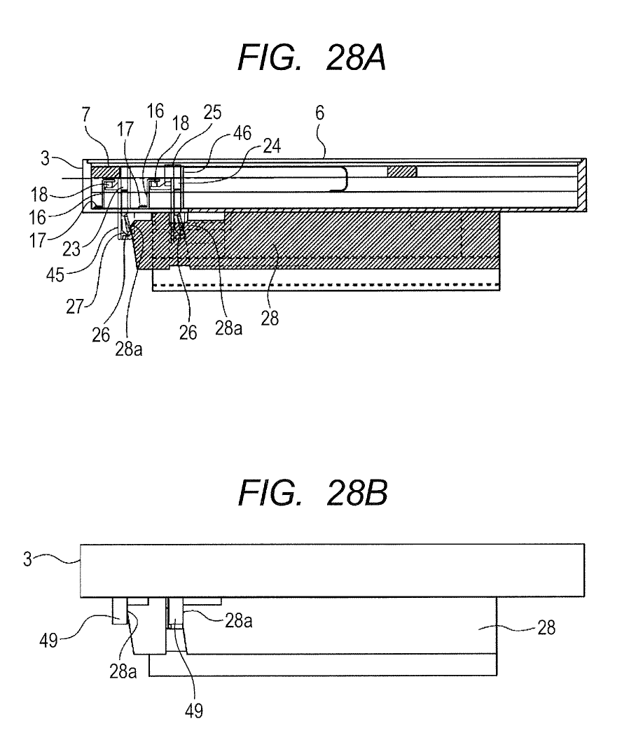

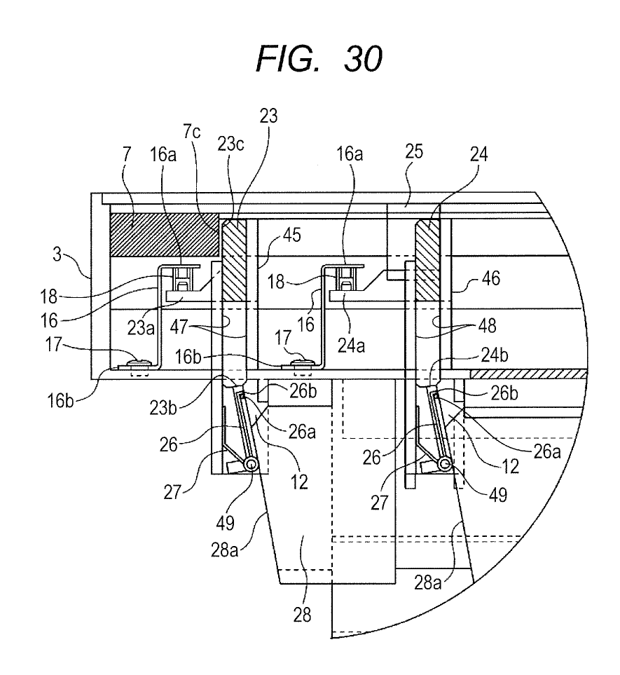

The guide rails 45 and the guide rails 46 are provided upright in a vertical direction of FIGS. 28A, 28B, and 30 at positions on the bottom surface 3b of the casing 3 and in the vicinity of the side surface 3c thereof. The guide rails 45 are formed of a pair of opposing rail members having a C-shaped cross section and serving as the guide rails 47, which pass through the bottom surface 3b of the casing 3 and communicate the inner side and the outer side of the casing 3. The guide rails 46 are formed of a pair of opposing rail members having a C-shaped cross section and serving as the guide rails 48, which pass through the bottom surface 3b of the casing 3 and communicate the inner side and the outer side of the casing 3.

The guide rails 45 for guiding the restraining member 23 so that the restraining member 23 can be raised and lowered are arranged in the vicinity of the home position of the image sensor section 7 and in the vicinity of the side surface 3c of the casing 3. The guide rails 46 for guiding the support member 24 so that the support member 24 can be raised and lowered are arranged within the range of the lower surface 6a of the original placing glass 6 at the position in the vicinity of the side surface 3c of the casing 3 and adjacent to the guide rails 45.

Also in this embodiment, the image reading apparatus 2 is transported in a state of being packaged with use of the packaging material 28. After that, in association with the user's operation of placing the packaging material 28 for packaging the image reading apparatus 2 at the time of packaging work, the support member 24 serving as the support unit supports the lower surface 6a of the original placing glass 6. Further, in association with the user's operation of removing the packaging material 28 at the time of unpackaging work, the support of the lower surface 6a of the original placing glass 6 is canceled. The support member 24 supports the lower surface 6a of the original placing glass 6 at a portion other than the portion of the original placing glass 6 which is supported by the casing 3. The support member 24 is movable between the support position for supporting the lower surface 6a of the original placing glass 6 and the retracted position retracted from the lower surface 6a of the original placing glass 6.

In association with the operation of placing and removing the packaging material 28, the restraining member 23 serving as the restraining unit is movable between the restraining position for restraining the image sensor section 7 at the home position and the canceling position for canceling the restraint of the image sensor section 7. The restraining member 23 and the support member 24 are configured separately. Protruding portions 28a of the packaging material 28 are provided at positions corresponding to the respective rocker arms 26. When the packaging material 28 is fixed to a bottom portion of the image reading apparatus 2, the protruding portions 28a of the packaging material 28 enter the respective opening portions 12 and abut against the rocker arms 26. Other components are similar to those in the sixth embodiment. At the time of unpackaging, the holding state of the original placing glass 6 and the restraining state of the image sensor section 7 can be canceled by only removing the packaging material. Therefore, the user does not need to carry out the canceling operation separately from the operation of removing the packaging material, and hence the usability is improved.

### Eighth Embodiment

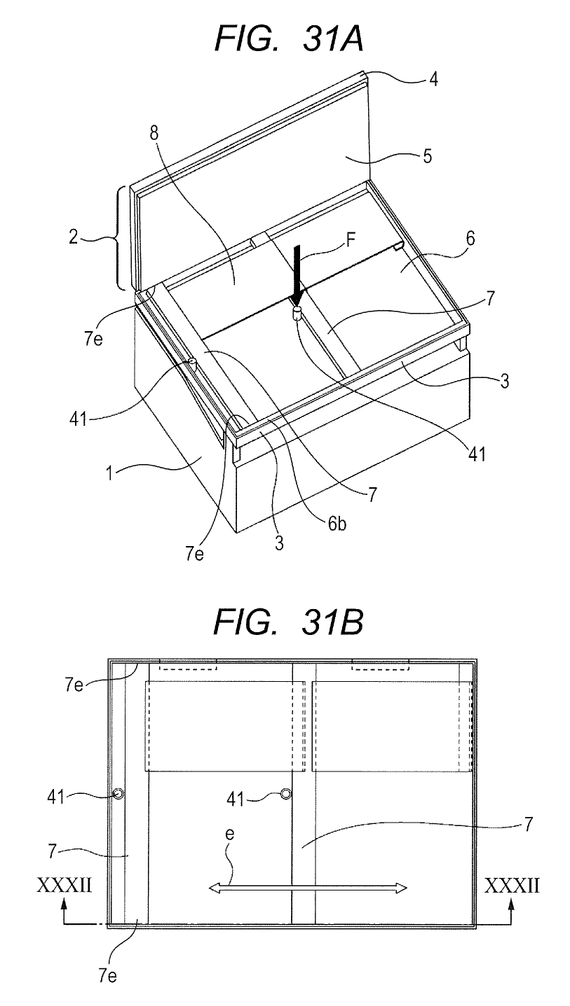

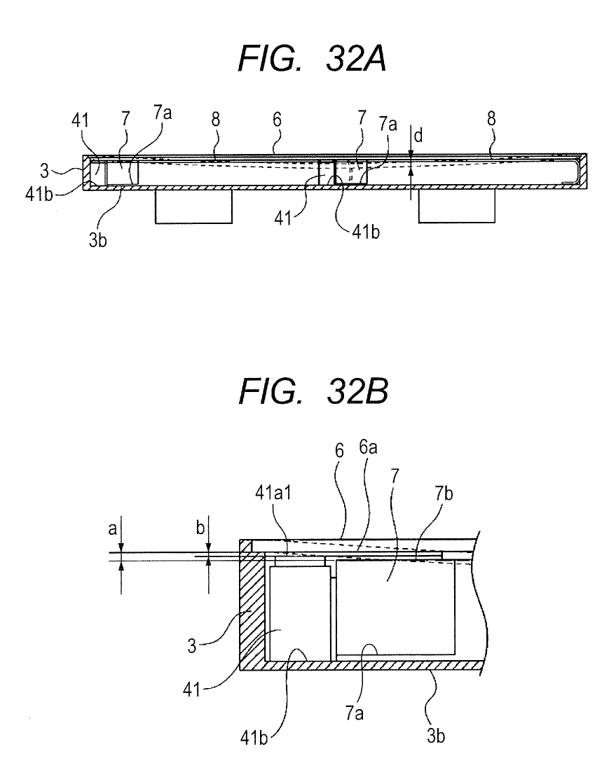

Next, referring to FIGS. 31A, 31B, 32A, and 32B, a configuration of an image reading apparatus according to an eighth embodiment of the present invention is described. In this embodiment, a support member 41 serves as the support unit for supporting the original placing glass 6 by abutting against the lower surface 6a of the original placing glass 6 at a portion other than the portion of the original placing glass 6 which is supported by the casing 3, and the support member 41 moves in association with the movement of the image sensor section 7. The support member is movable at a predetermined separation distance between the support member 41 and the lower surface 6a of the original placing glass 6. Components similar to those in the first to seventh embodiments are represented by the same reference symbols, and description thereof is therefore omitted herein.

The image sensor section 7 is movable in the arrow “e” direction of FIG. 31B from a position of the left end portion of the original placing glass 6 illustrated in FIGS. 31A, 31B, 32A, and 32B to a position of the reading operation, which is set in accordance with the size of the original placed on the original placing glass 6.

The image sensor section 7 moves by the drive unit (not shown) such as a motor. The position of the left end portion of the original placing glass 6 illustrated in FIGS. 31A, 31B, 32A, and 32B corresponds to the home position of the image sensor section 7.

The support member 41 of this embodiment is formed into a columnar or cylindrical shape having a height corresponding to a separation distance between the bottom surface 3b of the casing 3 and the lower surface 6a of the original placing glass 6. An elastic member 41a, which abuts against the lower surface 6a of the original placing glass 6 and supports the original placing glass 6, is provided at an upper portion of the support member 41. The support member 41 is integrally fixed to the image sensor section 7, and moves in association with the movement of the image sensor section 7.

As illustrated in FIG. 32B, the upper surface 7b of the image sensor section 7 is opposed to the lower surface 6a of the original placing glass 6 at the separation distance “a”. An upper surface 41a1 of the elastic member 41a of the support member 41 is opposed to the lower surface 6a of the original placing glass 6 at the separation distance “b” that is smaller than the separation distance “a”.

When the image reading apparatus 2 is transported, as illustrated in FIGS. 31A and 31B, the image sensor section 7 is fixed in a state of being moved to a position of substantially the center portion of the original placing glass 6. The support member 41 integrally fixed to the image sensor section 7 supports the lower surface 6a of the original placing glass 6 at substantially the center portion of the original placing glass 6.

The broken lines in the sectional view of FIG. 32A schematically indicate a limit to the shape of the original placing glass 6 which keeps the original placing glass 6 from damage thereto. FIG. 32A illustrates the maximum flexure amount “d” in this case. When the separation distance “b” between the upper surface 41a1 of the elastic member 41a of the support member 41 and the lower surface 6a of the original placing glass 6 is set smaller than the maximum flexure amount “d” at the limit to the shape of the original placing glass 6 which keeps the original placing glass 6 from damage thereto, the original placing glass 6 is supported by the support member 41 before the original placing glass 6 is damaged.

Accordingly, as illustrated in FIGS. 31A, 31B, and 32A, the image sensor section 7 is fixed in the state of being moved to the position of substantially the center portion of the original placing glass 6. The image reading apparatus 2 is transported under a state in which the support member 41 integrally fixed to the image sensor section 7 can support the lower surface 6a of the original placing glass 6 at substantially the center portion of the original placing glass 6. Accordingly, the original placing glass 6 is brought into a state of being supported from the inner side of the casing 3, and the original placing glass 6 is not distorted inward due to the vibration and shock at the time of transportation, resulting in a satisfactory holding state.

In this embodiment, the support member 41 is integrally fixed to the image sensor section 7. Accordingly, even when the original placing glass 6 is distorted inward of the casing 3, the separation distance “a” between the upper surface 7b of the image sensor section 7 and the lower surface 6a of the original placing glass 6 is larger than the separation distance “b” between the upper surface 41a1 of the elastic member 41a of the support member 41 and the lower surface 6a of the original placing glass 6. Accordingly, the lower surface 6a of the original placing glass 6 abuts against the upper surface 41a1 of the elastic member 41a of the support member 41 and is supported by the upper surface 41a1 before the lower surface 6a of the original placing glass 6 comes into contact with the image sensor section 7. Thus, even when the original placing glass 6 is distorted inward of the casing 3, the original placing glass 6 does not come into contact with the image sensor section 7. A lower surface 41b of the support member 41 functions as an abutment surface of the support member 41 which is supported by the casing 3.

The separation distance “a” between the upper surface 7b of the image sensor section 7 and the lower surface 6a of the original placing glass 6, and the separation distance “b” between the upper surface 41a1 of the elastic member 41a of the support member 41 and the lower surface 6a of the original placing glass 6 are set so as to satisfy a relationship of {a>b>0}. Accordingly, when the image sensor section 7 moves in the arrow “e” direction of FIG. 31B in the reading operation, the lower surface 6a of the original placing glass 6 and the upper surface 41a1 of the elastic member 41a of the support member 41 are not damaged by friction.

The lower surface 7a of the image sensor section 7 and the lower surface 41b of the support member 41 may be movable at the predetermined separation distance “c” from the bottom surface 3b of the casing 3 instead of being held in contact with the bottom surface 3b of the casing 3 at a distance of 0 mm. At this time, there is a condition that the separation distance “a” between the upper surface 7b of the image sensor section 7 and the lower surface 6a of the original placing glass 6, the separation distance between the upper surface 41a1 of the elastic member 41a of the support member 41 and the lower surface 6a of the original placing glass 6, and the separation distance “c” between the lower surface 41b of the support member 41 and the bottom surface 3b of the casing 3 satisfy a relationship of {a>b+c>0}. In this condition, under a state in which the original placing glass 6 is distorted inward of the casing 3 and the support member 41 supports the lower surface 6a of the original placing glass 6, the lower surface 6a of the original placing glass 6 abuts against the upper surface 41a1 of the elastic member 41a of the support member 41. When the image sensor section 7 is distorted, the support member 41 is lowered and the lower surface 41b of the support member 41 abuts against the bottom surface 3b of the casing 3. When the above-mentioned separation distances and the maximum flexure amount “d” of the original placing glass 6 satisfy a relationship of b+c<d at the position of the support member 41, it is possible to prevent the damage to the original placing glass 6. In the case described in this embodiment, “c” is zero, but “c” may be larger than zero.

The original placing glass 6 is distorted inward of the casing 3, and the lower surface 6a of the original placing glass 6 abuts against the elastic member 41a provided at the upper portion of the support member 41. Accordingly, a shock at the time when the lower surface 6a of the original placing glass 6 comes into contact with the support member 41 can be absorbed by the elasticity of the elastic member 41a, which is more effective in the protection of the original placing glass 6.

When the image reading apparatus 2 receives a shock in a period in which the image reading apparatus 2 is transported, or when the original placing glass 6 receives an external force and is distorted inward of the casing 3 at the time of the image reading operation, the support member 41 supports the lower surface 6a of the original placing glass 6. That is, a force for distorting the original placing glass 6 is transferred to the bottom surface 3b of the casing 3 via the support member 41. Accordingly, it is possible to protect the original placing glass 6 and the image sensor section 7.

The number of the support members 41 and the abutment area of the support member 41 abutting against the lower surface 6a of the original placing glass 6 may be set as appropriate depending on the area and thickness of the original placing glass 6.

When the image reading apparatus 2 is transported (when the image reading apparatus 2 does not perform the reading operation), as illustrated in FIGS. 31A, 31B, and 32A, the image sensor section 7 is moved to a position in the vicinity of substantially the center portion of the original placing glass 6.

Accordingly, the image sensor section 7 automatically performs a sequence of returning to the position of the left end portion of the original placing glass 6 illustrated in FIGS. 31A, 31B, 32A, and 32B at, for example, a timing at which the user turns ON the power of the image reading apparatus 2 or the image forming apparatus 1. The image sensor section 7 moves by the drive unit (not shown) such as a motor. The position of the left end portion of the original placing glass 6 illustrated in FIGS. 31A, 31B, 32A, and 32B corresponds to the home position of the image sensor section 7. Accordingly, the convenience of the user can be enhanced.

As described above, in this embodiment, the support member 41 is provided so as to move in association with the image sensor section 7. The support member 41 receives the force for distorting the original placing glass 6, and directly transfers the force to the casing 3. Accordingly, there is no need to move the support member 41 so as to operate (move) the image sensor 7, and the configuration for supporting the original placing glass 6 can be simplified and less complex. The support member 41 receives the force for distorting the original placing glass 6, and directly transfers the force to the casing 3. Accordingly, it is possible to reduce a ratio of the force for distorting the original placing glass 6, which is transferred to the image sensor section 7.

### Ninth Embodiment

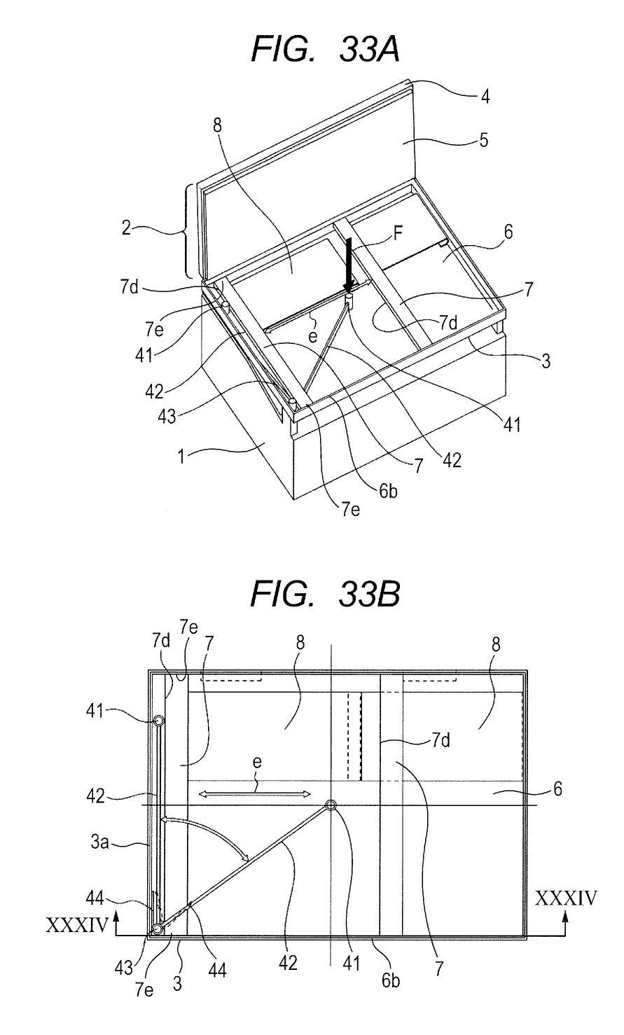

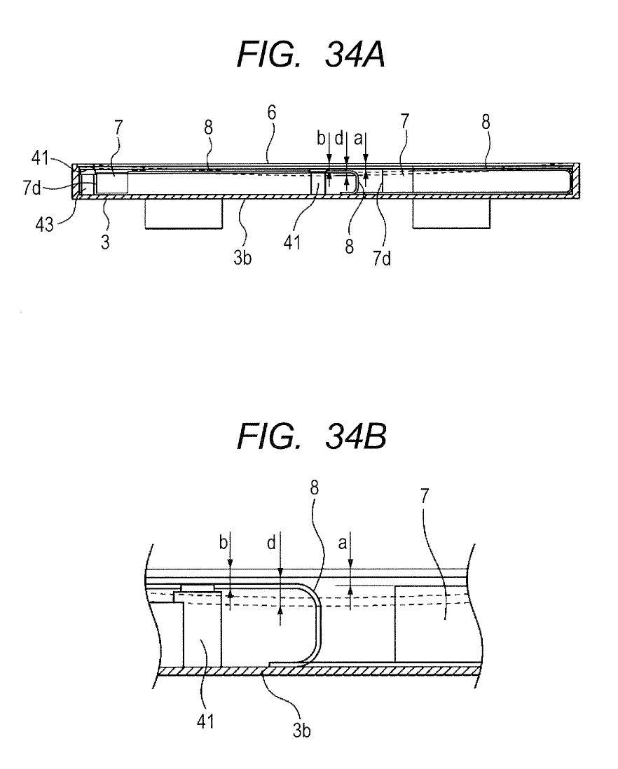

Next, referring to FIGS. 33A, 33B, 34A, and 34B, a configuration of an image reading apparatus according to a ninth embodiment of the present invention is described. In the eighth embodiment, the support member 41 serves as the support unit for supporting the original placing glass 6 by abutting against the lower surface 6a of the original placing glass 6 at a portion other than the portion of the original placing glass 6 which is supported by the casing 3, and the support member 41 is provided integrally with the image sensor section 7. In this embodiment, the support member 41 is provided separately from the image sensor section 7 so as to be independently movable in the normal direction to the lower surface 6a of the original placing glass 6. The support member 41 moves in association with the movement of the image sensor section 7 in a direction parallel to the lower surface 6a of the original placing glass 6. Components similar to those in the first to eighth embodiments are represented by the same reference symbols, and description thereof is therefore omitted herein.

The support member 41 is fixed to a tip end portion of an arm 42 provided so as to be pivotable about a pivot shaft 43, which is provided at a corner portion of the bottom surface 3b of the casing 3. A torsion coil spring 44 is fitted onto the pivot shaft 43. One end of the torsion coil spring 44 abuts against an inner wall surface of the side surface 3a of the casing 3, and another end of the torsion coil spring 44 is locked at the arm 42.

The arm 42 is constantly biased about the pivot shaft 43 in a clockwise direction of FIG. 33B by an elastic force of the torsion coil spring 44. Under a state in which the support member 41 abuts against a side surface 7d of the image sensor section 7 on the left side of FIG. 33B, the arm 42 moves in the direction parallel to the lower surface 6a of the original placing glass 6 in association with the movement of the image sensor section 7. When the support member 41 moves to a position in the vicinity of substantially the center portion of the original placing glass 6, the torsion coil spring 44 transitions to a free state of FIG. 33B, in which the spring is fully expanded and the elastic force thereof does not act, and the support member 41 does not further move and comes into a stationary state.

The image sensor section 7 moves from the position in the vicinity of the center portion in a leftward direction of FIG. 33B. Then, the side surface 7d of the image sensor section 7 on the left side of FIG. 33B abuts against the support member 41. Then, the arm 42 is pivoted about the pivot shaft 43 in a counterclockwise direction of FIG. 33B against the biasing force of the torsion coil spring 44. The support member 41 slides in abutment against the side surface 7d of the image sensor section 7 on the left side of FIG. 33B, and in this state, moves in a manner of drawing an arc with the arm 42 defining its radius. Then, the image sensor section 7 returns to the position of the left end portion of the original placing glass 6 illustrated in FIG. 33B, which corresponds to the home position. Then, the support member returns to the position in the vicinity of the side surface 3a of the casing 3 in association with the movement of the image sensor section 7.

As illustrated in FIG. 33B, the image sensor section 7 is fixed in a state of being moved to the position of substantially the center portion of the original placing glass 6. The image reading apparatus 2 is transported under a state in which the support member 41 following the image sensor section 7 can support the lower surface 6a of the original placing glass 6 at substantially the center portion of the original placing glass 6. Accordingly, the original placing glass 6 is brought into a state of being supported from the inner side of the casing 3. Accordingly, the original placing glass 6 is brought into a state in which the inward flexure due to the vibration and shock at the time of transportation is suppressed, resulting in a satisfactory holding state. That is, the force for distorting the original placing glass 6 is transferred to the bottom surface 3b of the casing 3 via the support member 41. At this time, the support member 41 is movable independently of the image sensor section 7 in the normal direction to the lower surface 6a of the original placing glass 6. Accordingly, it is possible to protect the original placing glass 6 and the image sensor section 7.

In this embodiment, the biasing force is constantly applied to the arm 42 with use of the torsion coil spring 44, but the torsion coil spring 44 may be replaced with a different elastic member such as a coil spring, and the elastic member may be arranged at a different position.

The number of the arms 42 and support members 41 may be increased as appropriate depending on the area and thickness of the original placing glass 6. Further, the method of moving the arm 42 and the support member 41 is not limited to the method in this embodiment, and various other methods may be employed instead. Other components are similar to those in the eighth embodiment. The support member 41 is provided so as to move in association with the image sensor section 7. The support member 41 receives the force for distorting the original placing glass 6, and directly transfers the force to the casing 3. Accordingly, there is no need to move the support member 41 so as to operate (move) the image sensor 7, and the configuration for supporting the original placing glass 6 can be simplified and less complex. The support member 41, which is movable independently of the image sensor section 7 in the normal direction to the lower surface 6a of the original placing glass 6, receives the force for distorting the original placing glass 6, and directly transfers the force to the casing 3. Accordingly, it is possible to reduce the ratio of the force for distorting the original placing glass 6, which is transferred to the image sensor section 7.

### Tenth Embodiment

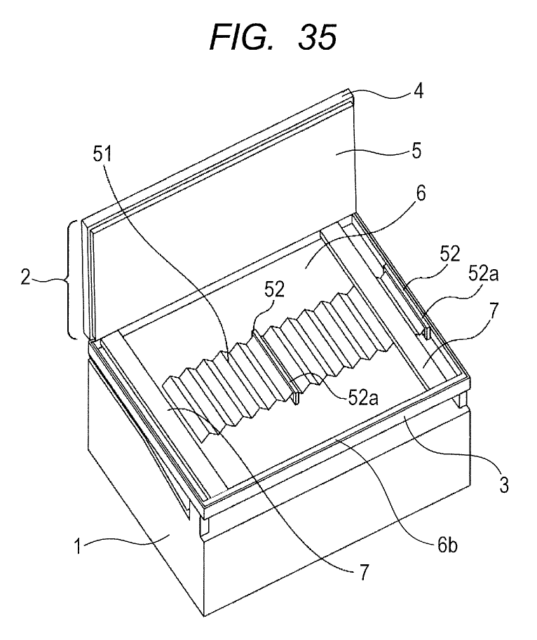

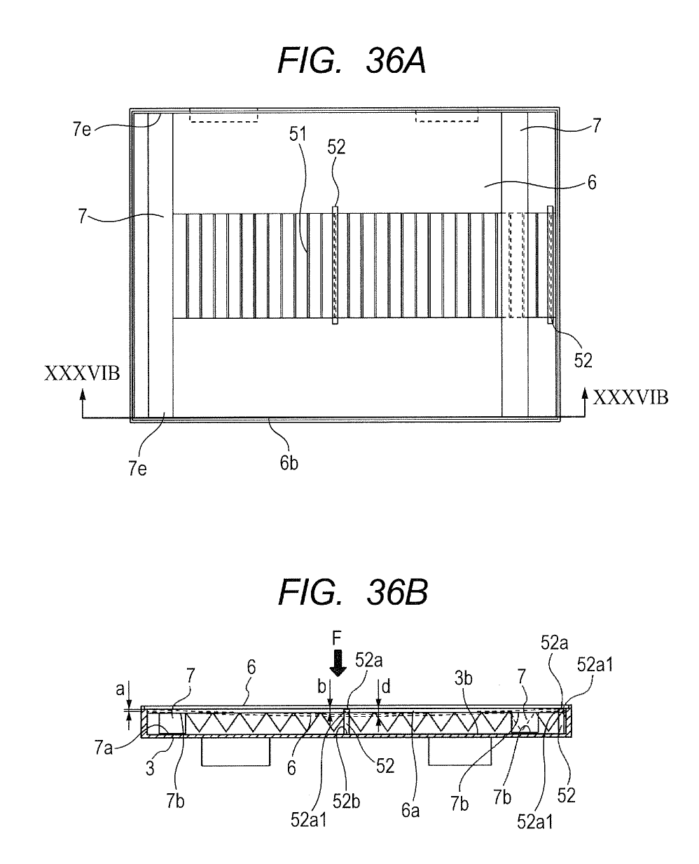

Next, referring to FIGS. 35, 36A, and 36B, a configuration of an image reading apparatus according to a tenth embodiment of the present invention is described. In this embodiment, a plate-like support member 52 serves as the support unit for supporting the original placing glass 6 by abutting against the lower surface 6a of the original placing glass 6 at a portion other than the portion of the original placing glass 6 which is supported by the casing 3.

The support member 52 is provided at substantially a center portion of a signal line bundle 51 in its longitudinal direction. The signal line bundle 51 is freely foldable between the bottom surface 3b of the casing 3 and the lower surface 6a of the original placing glass 6. The signal line bundle 51 connects the image sensor section 7 to a control section (not shown) of the image reading apparatus 2 so as to transmit an input/output signal. The support member 52 moves together with the signal line bundle 51, which expands and contracts in association with the movement of the image sensor section 7.

In FIGS. 35, 36A, and 36B, the signal line bundle transmits the input/output signal of the image sensor section 7. The plate-like support member 52 supports the lower surface 6a of the original placing glass 6. An elastic member 52a is provided at an upper portion of the support member 52. The signal line bundle 51 is freely foldable (bendable) into an accordion shape, and is connected to the support member 52 at a position in the vicinity of the center in a folding direction. One end of the signal line bundle 51 is connected to the image sensor section 7, and another end of the signal line bundle 51 is connected to the control section (not shown) provided inside the casing 3.

As illustrated in FIG. 36B, the separation distance “a” between the upper surface 7b of the image sensor section 7 and the lower surface 6a of the original placing glass 6, and the separation distance “b” between an upper surface 52a1 of the elastic member 52a of the support member 52 and the lower surface 6a of the original placing glass 6 satisfy a relationship of a>b.

The support member 52 moves between the bottom surface 3b of the casing 3 and the lower surface 6a of the original placing glass 6 in a floating manner under a state in which the support member 52 is held upright, together with the signal line bundle 51, which expands and contracts in association with the movement of the image sensor section 7. The support member 52 is movable at the predetermined separation distance “b” between the support member 52 and the lower surface 6a of the original placing glass 6.

Only when the original placing glass 6 receives a force in the arrow “F” direction of FIG. 36B, the lower surface 6a of the original placing glass 6 abuts against the elastic member 52a of the support member 52, and the support member 52 is lowered. Then, a lower surface 52b of the support member 52 abuts against the bottom surface 3b of the casing 3, and the lower surface 6a of the original placing glass 6 is supported by the support member 52.

Therefore, when the force in the arrow direction of FIG. 36B is applied to the original placing glass 6, the original placing glass 6 is supported by the support member 52 abutting against the bottom surface 3b of the casing 3, and the original placing glass 6 does not come into contact with the image sensor section 7. That is, the force for distorting the original placing glass 6 is transferred to the bottom surface 3b of the casing 3 via the support member 52. At this time, the support member 52 is movable independently of the image sensor section 7 in the normal direction to the lower surface 6a of the original placing glass 6. Accordingly, it is possible to protect the original placing glass 6 and the image sensor section 7.

In this embodiment, there has been described an example in which only the single plate-like support member is connected to the signal line bundle 51, but a plurality of support members 52 may be arranged. Other components are similar to those in the first to ninth embodiments, and similar effects can be obtained.

Further, the support member 52 is provided so as to move in association with the image sensor section 7. The support member 52 receives the force for distorting the original placing glass 6, and directly transfers the force to the casing 3. Accordingly, there is no need to move the support member 52 separately so as to operate (move) the image sensor 7, and the configuration for supporting the original placing glass 6 can be simplified and less complex. The support member 52, which is movable independently of the image sensor section 7 in the normal direction to the lower surface 6a of the original placing glass 6, receives the force for distorting the original placing glass 6, and directly transfers the force to the casing 3. Accordingly, it is possible to further suppress the transfer of the force for distorting the original placing glass 6 to the image sensor section 7 as compared to the ninth embodiment.

### Eleventh Embodiment

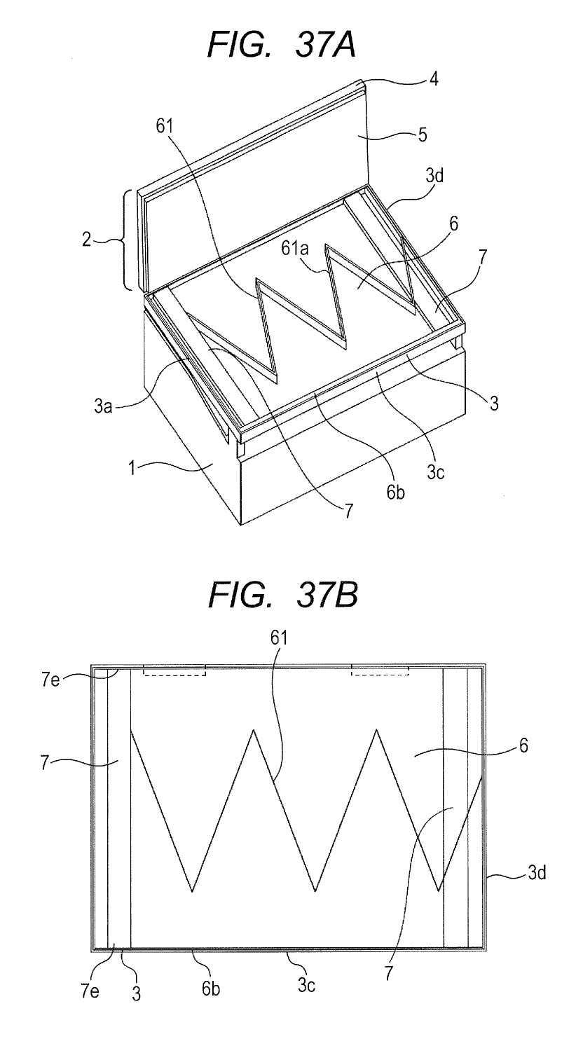

Next, referring to FIGS. 37A and 37B, a configuration of an image reading apparatus according to an eleventh embodiment of the present invention is described. Also in this embodiment, a support member 61 serves as the support unit for supporting the original placing glass 6 by abutting against the lower surface 6a of the original placing glass 6 at a portion other than the portion of the original placing glass 6 which is supported by the casing 3, and the support member 61 moves in association with the movement of the image sensor section 7. The support member is movable at a predetermined separation distance between the support member 61 and the lower surface 6a of the original placing glass 6.

The support member 61 is formed by connecting a plurality of plate-like members into an accordion shape, and is freely foldable (bendable) between the bottom surface 3b of the casing 3 and the lower surface 6a of the original placing glass 6. Each of the plurality of plate-like members is arranged in a state of being held upright in a direction perpendicular to the original placing glass 6. One end portion of the support member 61 is coupled to the image sensor section 7, and another end portion of the support member 61 is coupled to an inner wall surface of a side surface 3d of the casing 3 on the right side of FIG. 37B. Through the movement of the image sensor section 7, the support member 61 expands and contracts. The support member 61 moves between the bottom surface 3b of the casing 3 and the lower surface 6a of the original placing glass 6 in a floating manner under a state in which the support member 61 is held upright. The support member 61 is movable at the predetermined separation distance between the support member 61 and the lower surface 6a of the original placing glass 6.

In this embodiment, when the image reading apparatus 2 receives a shock in a period in which the image reading apparatus 2 is transported, or when the original placing glass 6 receives an external force and is distorted inward of the casing 3 at the time of the image reading operation, the lower surface 6a of the original placing glass 6 abuts against an elastic member 61a provided at an upper portion of the support member 61, and the support member 61 is lowered.

Then, a lower surface of the support member 61 abuts against the bottom surface 3b of the casing 3, and the lower surface 6a of the original placing glass 6 is supported by the support member 61.

Therefore, when the original placing glass 6 receives an external force and is distorted inward of the casing 3, the original placing glass 6 is supported by the support member 61 abutting against the bottom surface 3b of the casing 3, and the original placing glass 6 does not come into contact with the image sensor section 7. The support member 61 of this embodiment is structurally hard to buckle. Thus, the signal line bundle connected to the image sensor section 7 may serve also as the support member 61 that is freely foldable.

One end of the support member 61 formed of the signal line bundle is connected to the image sensor section 7, and another end of the support member 61 is connected to the control section (not shown) provided inside the casing 3. The signal line bundle forming the support member 61 connects the image sensor section 7 to the control section (not shown) of the image reading apparatus 2 so as to transmit the input/output signal.

The support member 61 for supporting the lower surface 6a of the original placing glass 6 only needs to expand and contract in a freely foldable manner in association with the image sensor section 7, and may be arranged so as to draw any trajectory of expansion and contraction such as a fan shape or the like.

As described above, in this embodiment, the support member 61 is provided so as to move in association with the image sensor section 7. The support member 61 receives the force for distorting the original placing glass 6, and directly transfers the force to the casing 3. Accordingly, there is no need to move the support member 61 separately so as to operate (move) the image sensor 7, and the configuration for supporting the original placing glass 6 can be simplified and less complex. The support member 61 receives the force for distorting the original placing glass 6, and directly transfers the force to the casing 3. Accordingly, it is possible to reduce the ratio of the force for distorting the original placing glass 6, which is transferred to the image sensor section 7.

### Twelfth Embodiment

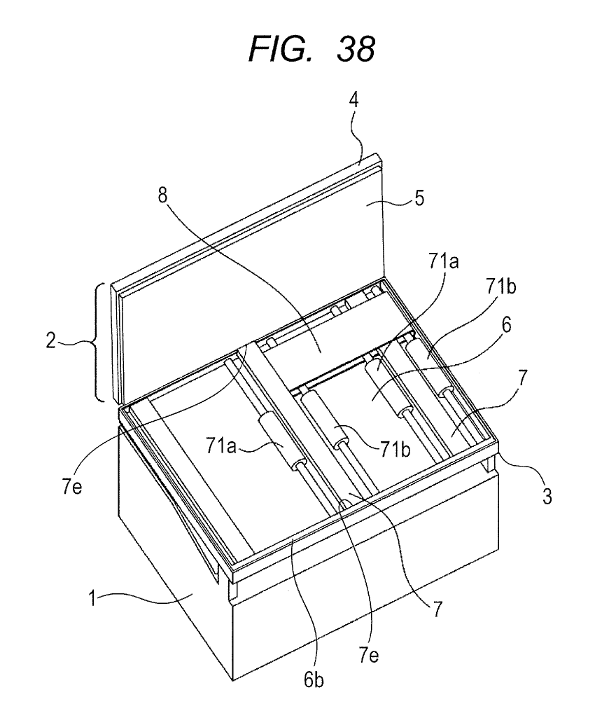

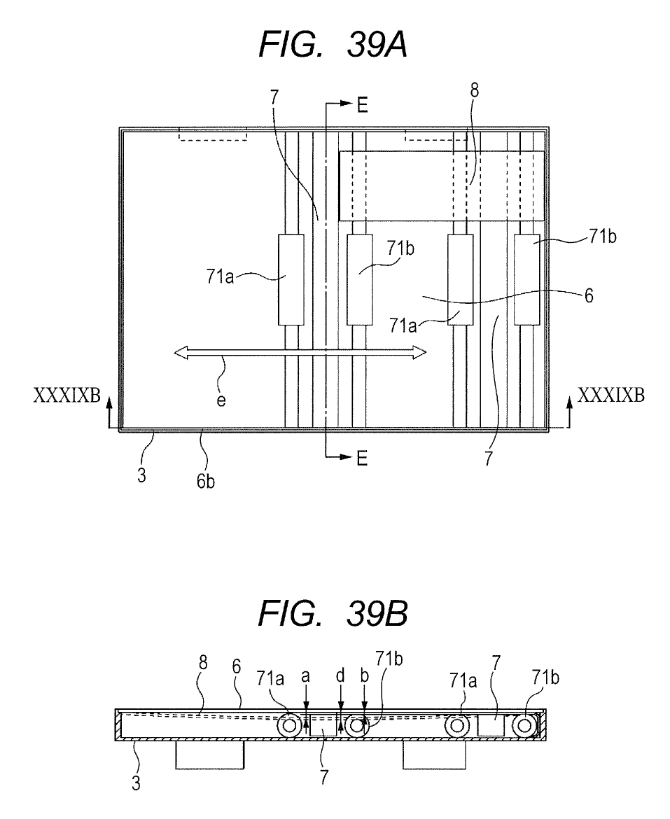

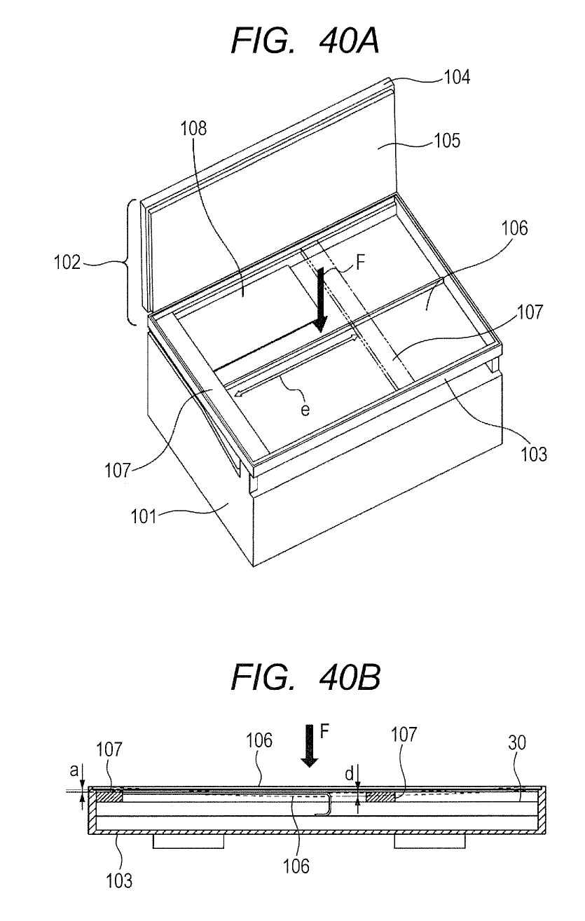

Next, referring to FIGS. 38, 39A, and 39B, a configuration of an image reading apparatus according to a twelfth embodiment of the present invention is described. In this embodiment, the image reading apparatus includes rollers 71a and 71b as rotary members, which serve as the support unit capable of supporting the original placing glass 6 by abutting against the lower surface 6a of the original placing glass 6 at a portion other than the portion of the original placing glass 6 which is supported by the casing 3.

The rollers 71a and 71b move in association with the movement of the image sensor section 7 while rolling on the bottom surface 3b of the casing 3. The rollers 71a and 71b are rotary members which are freely rotatable and movable in the moving direction of the image sensor section 7 at the predetermined separation distance “b” between the rollers 71a and 71b and the lower surface 6a of the original placing glass 6. At least a surface layer of each of the rollers 71a and 71b is an elastic member.

The rollers 71a and 71b maintain the predetermined separation distance “b” from the lower surface 6a of the original placing glass 6, and also maintain a constant separation distance from the image sensor section 7. In this state, the rollers 71a and 71b travel in the arrow “e” direction of FIG. 39A by a drive source (not shown) such as a motor. Each of the rollers 71a and 71b is an elastic member. Therefore, even when the separation distance “b” between the rollers 71a and 71b and the lower surface 6a of the original placing glass 6 is set to zero, there is no risk of damaging the lower surface 6a of the original placing glass 6 when the surfaces of the rollers 71a and 71b slide on the lower surface 6a of the original placing glass 6.

The rollers 71a and 71b are capable of traveling in association with the image sensor section 7 while constantly and actively supporting the lower surface 6a of the original placing glass 6. Further, a lower portion of each of the rollers 71a and 71b functions as an abutment surface abutting against the bottom surface 3b of the casing 3, to thereby transfer the force from the original placing glass 6 to the casing 3. Therefore, the lower surface 6a of the original placing glass 6 can be supported more actively. When the image reading apparatus 2 is transported, the position in the vicinity of the line E of FIG. 39A is set as the home position of the image sensor section 7, with the result that the vicinity of the center portion of the lower surface 6a of the original placing glass 6 can be supported reliably. Other components are similar to those in the first to eleventh embodiments, and similar effects can be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2011-191221, filed Sep. 2, 2011, and 2012-178122, filed Aug. 10, 2012 which are hereby incorporated by reference herein in their entirety.

What is claimed is:

1. An image reading apparatus, comprising:
a placing member on which an original is to be placed;
a reading section arranged so as to be opposed to the original across the placing member and reading an image of the original placed on the placing member;
a casing which supports an outer peripheral edge portion of the placing member; and
a support member supporting a portion other than the outer peripheral edge portion of the placing member, the support member having an abutment portion abutting against the casing, the support member being capable of supporting the placing member under a state in which the abutment portion abuts against the casing.

2. An image reading apparatus according to claim 1, wherein the reading section has an abutment portion abutting against the casing so that the reading section is supported by the casing, the abutment portion of the reading section being different from the abutment portion of the support member.

3. An image reading apparatus according to claim 1, wherein the support member is movable between a support position capable of supporting the placing member and a retracted position retracted from the placing member relative to the support position.

4. An image reading apparatus according to claim 3, wherein the reading section is configured to read the image of the original while moving, and
wherein, when the support member is situated at the support position, the support member restricts movement of the reading section, and when the support member is situated at the retracted position, the support member avoids restricting the movement of the reading section.

5. An image reading apparatus according to claim 3, further comprising a restricting member movable between a restricting position for restricting movement of the reading section and a restriction canceling position for canceling the restriction, the restricting member moving from the restricting position to the restriction canceling position in association with movement of the support member from the support position to the retracted position.

6. An image reading apparatus according to claim 5, wherein the support member and the restricting member are configured to move integrally.

7. An image reading apparatus according to claim 1, wherein the support member is configured to move in a direction parallel to a placing surface of the placing member, on which the original is to be placed, in association with movement of the reading section.

8. An image reading apparatus according to claim 7, wherein the support member is movable relative to the reading section in a normal direction to the placing surface.

9. An image reading apparatus according to claim 7, wherein the support member is separated from the placing member under a state in which the placing member is not distorted.

10. An image reading apparatus according to claim 7, wherein the support member is separated from the casing under a state in which the placing member is not distorted.

11. An image reading apparatus according to claim 1, wherein the reading section is separated from the placing member under a state in which the support member supports the placing member.

12. An image reading apparatus according to claim 7, wherein the support member has a bending portion which is freely bendable, the bending portion having one end coupled to the reading section, and having another end coupled to the casing, the bending portion being bendable in association with the movement of the reading section.

13. An image reading apparatus according to claim 12, wherein the bending portion has a signal line bundle connected to the reading section.

14. An image reading apparatus according to claim 1, wherein the support member is a rotary member which is rotatable and movable in a moving direction of the reading section.

15. An image reading apparatus according to claim 3, wherein, when the support member moves from the retracted position to the support position, a part of the support member which abuts against the placing member moves in a normal direction to a placing surface of the placing member, on which the original is to be placed.

16. An image reading apparatus according to claim 3, wherein, when a power of the image reading apparatus is turned ON under a state in which the support member is situated at the support position, the support member moves to the retracted position.

17. An image reading apparatus according to claim 3, wherein the support member moves from the support position to the retracted position in association with an operation in which a protective member placed on a main body of the image reading apparatus and protecting the image reading apparatus is removed from the main body.

18. An image reading apparatus according to claim 1, wherein the support member is configured to support a center portion of the placing member.

19. An image reading apparatus according to claim 1, wherein a part of the support member which abuts against the placing member is an elastic portion.

20. An image forming apparatus, comprising:
the image reading apparatus according to claim 1; and
an image forming unit for forming an image on a recording material based on information regarding an image of an original, which is read by the image reading apparatus.
